(19) United States
(12) Patent Application Publication
(10) Pub. No.: US 2025/0279234 A1
(43) Pub. Date: Sep. 4, 2025

(54) WOUND CORE

(71) Applicant: NIPPON STEEL CORPORATION, Tokyo (JP)

(72) Inventors: Takahito MIZUMURA, Tokyo (JP); Hisashi MOGI, Tokyo (JP); Masaru TAKAHASHI, Tokyo (JP)

(73) Assignee: NIPPON STEEL CORPORATION, Tokyo (JP)

(21) Appl. No.: 18/857,522

(22) PCT Filed: Jun. 21, 2023
(86) PCT No.: PCT/JP2023/022934

§ 371 Date: Oct. 17, 2024

(30) Foreign Application Priority Data
Jun. 22, 2022 (JP) 2022-100293

(51) Int. Cl. H01F 27/245

(52) U.S. Cl. CPC H01F 27/2455

(57) ABSTRACT

In this wound core, the average distance of first-group joint portions and the average distance of second-group joint portions determined under predetermined conditions satisfy predetermined conditions.

### TECHNICAL FIELD OF THE INVENTION

The present disclosure relates to a wound core.

The present application claims priority based on Japanese Patent Application No. 2022-100293 filed in Japan on Jun. 22, 2022, the contents of which are incorporated herein by reference.

### RELATED ART

A wound core is widely used as a magnetic core for a transformer, a reactor, a noise filter, or the like. Conventionally, reduction of iron loss occurring in a core has been one of important problems from the viewpoint of high efficiency and the like, and reduction of iron loss has been studied from various viewpoints.

For example, Patent Document 1 discloses a wound core in which a plurality of core materials each having at least one cutting portion are wound for each winding and a rectangular window portion is provided at the center, in which a space factor of the core material at a corner portion is lower than a space factor of the core material at a side portion excluding the corner portion.

### CITATION LIST

### Patent Document

Patent Document 1: Japanese Unexamined Patent Application, First Publication No. 2015-141930

### SUMMARY OF INVENTION

### Problems to be Solved by the Invention

Currently, there is a demand for a wound core in which noise is suppressed more than in the case of Patent Document 1.

The present disclosure is an invention that has been made in view of the above problems, and provides a wound core in which noise is suppressed.

### Means for Solving the Problem

In order to solve the above problem, the present invention proposes the means described below.

<1> A wound core according to Aspect 1 of the present invention is:
a wound core formed by laminating, in a sheet thickness direction, a plurality of bent bodies formed from a grain-oriented electrical steel sheet, in which
the wound core has a plurality of flat parts and a plurality of corner portions,
the bent body has a plurality of flat regions and a plurality of bent regions adjacent to the flat regions,
a radius of curvature of each of the bent regions is 5.0 mm or less,
the bent body has one or more joint portions in which end surfaces of the grain-oriented electrical steel sheets in a longitudinal direction face each other, and
when the bent body disposed on the innermost side is defined as a first bent body and a flat region where the joint portion of the first bent body is present is defined as a reference flat region, the joint portion of each of the plurality of bent bodies is located in the flat part having the reference flat region, and
in a side view of the wound core,
when one bent region adjacent to the reference flat region is defined as a first bent region,
the other bent region adjacent to the reference flat region is defined as a second bent region,
an imaginary line passing through an end point of the first bent region on the reference flat region side and parallel to the sheet thickness direction of the reference flat region is defined as a first imaginary line,
an imaginary line passing through an end point of the second bent region on the reference flat region side and parallel to the sheet thickness direction of the reference flat region is defined as a second imaginary line,
among the joint portions of the flat part having the reference flat region, the joint portion located between the first imaginary line and the second imaginary line and having the shortest length from the first imaginary line to the end surface of the joint portion on the first imaginary line side along the longitudinal direction of the reference flat region is defined as a first shortest joint portion,
among the joint portions in the bent bodies adjacent in the sheet thickness direction to the bent body having the first shortest joint portion, the joint portion located between the first imaginary line and the second imaginary line and having a shorter length from the first imaginary line to the end surface of the joint portion on the first imaginary line side along the longitudinal direction of the reference flat region is defined as a first end joint portion,
among the joint portions of the flat part having the reference flat region, the joint portion located between the first imaginary line and the second imaginary line and having the shortest length from the second imaginary line to the end surface of the joint portion on the second imaginary line side along the longitudinal direction of the reference flat region is defined as a second shortest joint portion,
among the joint portions in the bent body adjacent in the sheet thickness direction to the bent body having the second shortest joint portion, the joint portion located between the first imaginary line and the second imaginary line and having a shorter length from the second imaginary line to the end surface of the joint portion on the second imaginary line side along the longitudinal direction of the reference flat region is defined as a second end joint portion,
an imaginary line passing through the end surface of the first shortest joint portion on the first imaginary line side and parallel to the sheet thickness direction of the reference flat region is defined as an imaginary line A,
an imaginary line passing through the end surface of the first end joint portion on the first imaginary line side and parallel to the sheet thickness direction of the reference flat region is defined as an imaginary line B,
an imaginary line passing through the end surface of the second shortest joint portion on the second imaginary line side and parallel to the sheet thickness direction of the reference flat region is defined as an imaginary line C,
an imaginary line passing through the end surface of the second end joint portion on the second imaginary line side and parallel to the sheet thickness direction of the reference flat region is defined as an imaginary line D,
among the joint portions of the flat part having the reference flat region, the joint portion located between the imaginary line A and the imaginary line B is defined as a first-group joint portion,
among the joint portions of the flat part having the reference flat region, the joint portion located between the imaginary line C and the imaginary line D is defined as a second-group joint portion,
an average of lengths from the first imaginary line to the end surface of each of the first-group joint portions on the first imaginary line side along the longitudinal direction of the reference flat region is defined as <Lᵢ>, and
an average of lengths from the second imaginary line to the end surface of each of the second-group joint portions on the second imaginary line side along the longitudinal direction of the reference flat region is defined as <L_{O}>,
the wound core satisfies the following expressions (1) and (2).

$$2 mm \leq 〈 {L}_{i} 〉 < 25 mm \qquad ( 1 )$$

$$1.22 * 〈 Li 〉 \leq 〈 {L}_{O} 〉 \qquad ( 2 )$$

<2> According to Aspect 2 of the present invention, in the wound core of Aspect 1,
the number of first-group joint portions may be equal to the number of second-group joint portions, and
among a quotient and a remainder obtained by dividing the number of joint portions in the flat part located between the first imaginary line and the second imaginary line and having the reference flat region by the number of first-group joint portions, k, which is the quotient, may satisfy the following expression (3).

$$9 \leq k \leq 20 \qquad ( 3 )$$

<3> According to Aspect 3 of the present invention, in the wound core of Aspect 1 or 2,
the bent bodies may have the joint portion in each of two flat regions facing each other,
the first bent body may have the reference flat region and a second reference flat region facing the reference flat region, and
the joint portion of each of the plurality of bent bodies may be located in the flat part having the reference flat region and the flat part having the second reference flat region, and
in a side view of the wound core,
when one bent region adjacent to the second reference flat region is defined as a third bent region,
the other bent region adjacent to the second reference flat region is defined as a fourth bent region,
an imaginary line passing through an end point of the third bent region on the second reference flat region side and parallel to the sheet thickness direction of the second reference flat region is defined as a third imaginary line,
an imaginary line passing through an end point of the fourth bent region on the second reference flat region side and parallel to the sheet thickness direction of the second reference flat region is defined as a fourth imaginary line,
among the joint portions of the flat part having the second reference flat region, the joint portion located between the third imaginary line and the fourth imaginary line and having the shortest length from the third imaginary line to the end surface of the joint portion on the third imaginary line side along the longitudinal direction of the second reference flat region is defined as a third shortest joint portion,
among the joint portions in the bent bodies adjacent in the sheet thickness direction to the bent body having the third shortest joint portion, the joint portion located between the third imaginary line and the fourth imaginary line and having a shorter length from the third imaginary line to the end surface of the joint portion on the third imaginary line side along the longitudinal direction of the second reference flat region is defined as a third end joint portion,
among the joint portions of the flat part having the second reference flat region, the joint portion located between the third imaginary line and the fourth imaginary line and having the shortest length from the fourth imaginary line to the end surface of the joint portion on the fourth imaginary line side along the longitudinal direction of the second reference flat region is defined as a fourth shortest joint portion,
among the joint portions in the bent body adjacent in the sheet thickness direction to the bent body having the fourth shortest joint portion, the joint portion located between the third imaginary line and the fourth imaginary line and having a shorter length from the fourth imaginary line to the end surface of the joint portion on the fourth imaginary line side along the longitudinal direction of the second reference flat region is defined as a fourth end joint portion,
an imaginary line passing through the end surface of the third shortest joint portion on the third imaginary line side and parallel to the sheet thickness direction of the second reference flat region is defined as an imaginary line E,
an imaginary line passing through the end surface of the third end joint portion on the third imaginary line side and parallel to the sheet thickness direction of the second reference flat region is defined as an imaginary line F,
an imaginary line passing through the end surface of the fourth shortest joint portion on the fourth imaginary line side and parallel to the sheet thickness direction of the second reference flat region is defined as an imaginary line G,
an imaginary line passing through the end surface of the fourth end joint portion on the fourth imaginary line side and parallel to the sheet thickness direction of the second reference flat region is defined as an imaginary line H,
among the joint portions of the flat part having the second reference flat region, the joint portion located between the imaginary line E and the imaginary line F is defined as a third-group joint portion,
among the joint portions of the flat part having the second reference flat region, the joint portion located between the imaginary line G and the imaginary line H is defined as a fourth-group joint portion,
an average of lengths from the third imaginary line to the end surface of each of the third-group joint portions on the third imaginary line side along the longitudinal direction of the second reference flat region is defined as <L₂ᵢ>, and
an average of lengths from the fourth imaginary line to the end surface of each of the fourth-group joint portions on the fourth imaginary line side along the longitudinal direction of the second reference flat region is defined as <L_{2O}>,
the wound core may satisfy the following expressions (4) and (5).

$$2 mm \leq 〈 {L}_{2 i} 〉 < 25 mm \qquad ( 4 )$$

$$1.22 * 〈 {L}_{2 i} 〉 \leq 〈 {L}_{2 O} 〉 \qquad ( 5 )$$

<4> According to Aspect 4 of the present invention, in the wound core of Aspect 3,
the number of third-group joint portions may be equal to the number of fourth-group joint portions, and
among a second quotient and a second remainder obtained by dividing the number of joint portions in the flat part located between the third imaginary line and the fourth imaginary line and having the second reference flat region by the number of third-group joint portions, k2, which is the second quotient, may satisfy the following expression (6).

$$9 \leq k 2 \leq 20 \qquad ( 6 )$$

<5> According to Aspect 5 of the present invention, in the wound core according to any one of Aspects 1 to 4, a bending angle of the bent region may be 30° to 60°.

### Effects of the Invention

According to the above aspects of the present disclosure, it is possible to provide a wound core in which noise is suppressed.

### BRIEF DESCRIPTION OF THE DRAWINGS

FIG. 1 is a perspective view illustrating a wound core according to a first aspect.

FIG. 2 is a side view of the wound core in FIG. 1.

FIG. 3 is a side view illustrating a wound core according to a second aspect.

FIG. 4 is a side view illustrating a wound core according to a third aspect.

FIG. 5 is a side view illustrating a wound core according to a fourth aspect.

FIG. 6 is an enlarged side view of the vicinity of a corner portion of the wound core in FIG. 1.

FIG. 7 is an enlarged side view of an example of a bent region.

FIG. 8 is a side view of a bent body of the wound core in FIG. 1.

FIG. 9 is a side view of a wound core of a fifth aspect.

FIG. 10 is a side view of a wound core of a sixth aspect.

FIG. 11 is a side view of a wound core of a seventh aspect.

FIG. 12 is an explanatory view illustrating a first example of a wound core manufacturing apparatus used in a wound core manufacturing method.

FIG. 13 is a schematic view illustrating dimensions of a wound core manufactured at the time of characteristic evaluation.

### EMBODIMENTS OF THE INVENTION

### (Wound Core)

Hereinafter, the wound core of the present disclosure will be described. Note that a numerical range described below includes the lower limit and the upper limit. A numerical value indicated as “more than” or “less than” is not included in the numerical range. In addition, unless otherwise specified, the unit “%” regarding the chemical composition means “mass %”.

Terms such as “parallel”, “perpendicular”, “identical”, and “at right angle”, values of length and angle, and the like, which specify shapes, geometric conditions, and degrees thereof, used in the present specification are not to be bound by a strict meaning but are to be interpreted including a range in which similar functions can be expected. In the present disclosure, substantially 90° allows an error of +3°, and means a range of 87° to 93°.

The wound core according to the present disclosure is a wound core formed by laminating, in a sheet thickness direction, a plurality of bent bodies formed from a grain-oriented electrical steel sheet. The grain-oriented electrical steel sheet used for the wound core is preferably a coated grain-oriented electrical steel sheet, in which a coating is formed on at least one surface of the grain-oriented electrical steel sheet. Also, in the case of a coated grain-oriented electrical steel sheet, the wound core according to the present disclosure is preferably a wound core formed by laminating, in a sheet thickness direction, a plurality of bent bodies formed from a grain-oriented electrical steel sheet such that the coating of the grain-oriented electrical steel sheet is on an outer side.

The bent body of the wound core of the present disclosure has a flat region and a bent region adjacent to the flat region. Moreover, the bent body of the wound core of the present disclosure has one or more joint portions in which end surfaces of the grain-oriented electrical steel sheets in a longitudinal direction face each other. In the following description, a case where the grain-oriented electrical steel sheet is a coated grain-oriented electrical steel sheet will be described, but the present invention is not limited to the following configuration. Hereinafter, each configuration of the wound core of the present disclosure will be described in detail.

### “Coated Grain-Oriented Electrical Steel Sheet”

The coated grain-oriented electrical steel sheet in the present disclosure includes at least a grain-oriented electrical steel sheet (sometimes referred to as a “base steel sheet” in the present disclosure) and a coating formed on at least one surface of the base steel sheet.

The coated grain-oriented electrical steel sheet has at least a primary coating as the coating, and may further have another layer as necessary. Examples of the other layer include a secondary coating provided on the primary coating.

Hereinafter, the configuration of the coated grain-oriented electrical steel sheet will be described.

### <Grain-Oriented Electrical Steel Sheet>

In the coated grain-oriented electrical steel sheet constituting the wound core 10 according to the present disclosure, the base steel sheet is a steel sheet in which the orientation of grains is highly accumulated in a {110}<001> orientation. The base steel sheet has excellent magnetic properties in a rolling direction.

The base steel sheet used for the wound core according to the present disclosure is not particularly limited. As the base steel sheet, a known grain-oriented electrical steel sheet can be appropriately selected and used. As the grain-oriented electrical steel sheet, an oriented electrical steel strip described in JIS C 2553:2019 can be adopted. Hereinafter, an example of the base steel sheet will be described, but the base steel sheet is not limited to the following example.

The chemical composition of the base steel sheet is not particularly limited, but for example, it is preferable that the base steel sheet contains, in mass %, Si: 0.8% to 7%, C: more than 0% and 0.085% or less, acid-soluble Al: 0% to 0.065%, N: 0% to 0.012%, Mn: 0% to 1%, Cr: 0% to 0.3%, Cu: 0% to 0.4%, P: 0% to 0.5%, Sn: 0% to 0.3%, Sb: 0% to 0.3%, Ni: 0% to 1%, S: 0% to 0.015%, and Se: 0% to 0.015%, and the remainder is Fe and impurity elements.

The above chemical composition of the base steel sheet is a preferred chemical component for controlling the crystal orientation to a Goss texture accumulated in the {110}<001> orientation.

Among the elements other than Fe in the base steel sheet, Si and C are basic elements (essential elements). When the Si content of the base steel sheet is 2.0% or more in mass %, eddy-current loss of the wound core is suppressed, which is preferable. The Si content of the base steel sheet is more preferably 3.0% or more. In addition, when the Si content of the base steel sheet is 5.0% or less in mass %, fracture of the steel sheet is less likely to occur in a hot rolling step and cold rolling, which is preferable. The Si content of the base steel sheet is more preferably 4.5% or less.

The base steel sheet may contain, as optional elements, acid-soluble Al, N, Mn, Cr, Cu, P, Sn, Sb, Ni, S, and Se. Since these optional elements may be contained depending on the object, the lower limit is 0%. In addition, even if these optional elements are contained as impurity elements, the effects of the present disclosure are not impaired.

The grain-oriented electrical steel sheet generally undergoes purification annealing during secondary recrystallization. In the purification annealing, an inhibitor-forming element is discharged to the outside of the system. Particularly, for N and S, the concentration remarkably decreases to 50 ppm or less. Under normal purification annealing conditions, the concentration reaches 9 ppm or less, further 6 ppm or less, and a degree that cannot be detected by general analysis (1 ppm or less) if purification annealing is sufficiently performed.

In the base steel sheet, the remainder of the basic elements and the optional elements is Fe and impurity elements. Here, the “impurity element” means an element unintentionally mixed from ore as a raw material, scrap, a manufacturing environment, or the like when the base steel sheet is industrially manufactured.

The chemical component of the base steel sheet may be measured by a general analysis method of steel. For example, the chemical component of the base steel sheet may be measured by inductively coupled plasma-atomic emission spectrometry (ICP-AES). Specifically, for example, the chemical component can be specified by acquiring a test piece of 35 mm square from a center position in a width direction of the base steel sheet after removal of a coating, and performing measurement under a condition based on a calibration curve created in advance using an apparatus (measurement apparatus) such as ICPS-8100 manufactured by Shimadzu Corporation. C and S may be measured by a combustion-infrared absorption method, and N may be measured by an inert gas fusion-thermal conductivity method.

The chemical component of the base steel sheet is a component obtained by analyzing a component of a steel sheet obtained by removing a glass coating, a coating containing phosphorus, and the like described later from a grain-oriented electrical steel sheet by a method described later as the base steel sheet.

### <Primary Coating>

The primary coating is a coating directly formed on a surface of a grain-oriented electrical steel sheet as a base steel sheet without any other layer or film. Examples of the primary coating include a glass coating. Examples of the glass coating include a coating having one or more oxides selected from forsterite (Mg₂SiO₄), spinel (MgAl₂O₄), and cordierite (Mg₂Al₄Si₅O₁₆). For example, a coating containing phosphorus described later may be formed as a primary coating without forming a glass coating on a surface of a grain-oriented electrical steel sheet.

When the primary coating is a glass coating, the method for forming the glass coating is not particularly limited, and can be appropriately selected from known methods. For example, the method includes a method in which an annealing separator containing one or more selected from magnesia (MgO) and alumina (Al₂O₃) is applied to a cold-rolled steel sheet, and then finish annealing is performed.

The annealing separator also has an effect of suppressing sticking of steel sheets during finish annealing. For example, when finish annealing is performed by applying the annealing separator containing magnesia, silica contained in the base steel sheet reacts with the annealing separator to form a glass coating containing forsterite (Mg₂SiO₄) on a base steel sheet surface.

The thickness of the primary coating is not particularly limited, but is preferably, for example, 0.5 μm or more and 3 μm or less from the viewpoint of forming the primary coating on the entire surface of a base steel sheet and suppressing peeling.

### <Other Coatings>

The coated grain-oriented electrical steel sheet may include a coating other than the primary coating. For example, it is preferable that the coated grain-oriented electrical steel sheet have a coating containing phosphorus as other film (a secondary coating) on the primary coating. By having a coating containing phosphorus, insulation properties can be improved. The coating containing phosphorus is a coating formed on the outermost surface of the grain-oriented electrical steel sheet. When the grain-oriented electrical steel sheet has a glass coating or an oxide film as a primary coating, the grain-oriented electrical steel sheet is formed on the primary coating. By forming a coating containing phosphorus on the glass coating formed as a primary coating on the surface of the base steel sheet, high adhesion can be secured.

The coating containing phosphorus can be appropriately selected from conventionally known coatings. The coating containing phosphorus is preferably a phosphate-based coating, and particularly preferably a coating containing one or more of aluminum phosphate and magnesium phosphate as main components, and further containing one or more of chromium and silicon oxide as accessory components. According to the phosphate-based coating, insulation properties of the steel sheet are secured, and tension is imparted to the steel sheet to be excellent in reduction of iron loss.

When the other film is a coating containing phosphorus, the thickness of the coating containing phosphorus is not particularly limited, but is preferably 0.5 μm or more and 3 μm or less from the viewpoint of securing insulation properties.

### <Sheet Thickness>

The sheet thickness of the coated grain-oriented electrical steel sheet is not particularly limited, and may be appropriately selected according to the application and the like, but is usually in the range of 0.10 mm to 0.50 mm, preferably 0.13 mm to 0.35 mm, and more preferably in the range of 0.15 mm to 0.30 mm.

### (Configuration of Wound Core)

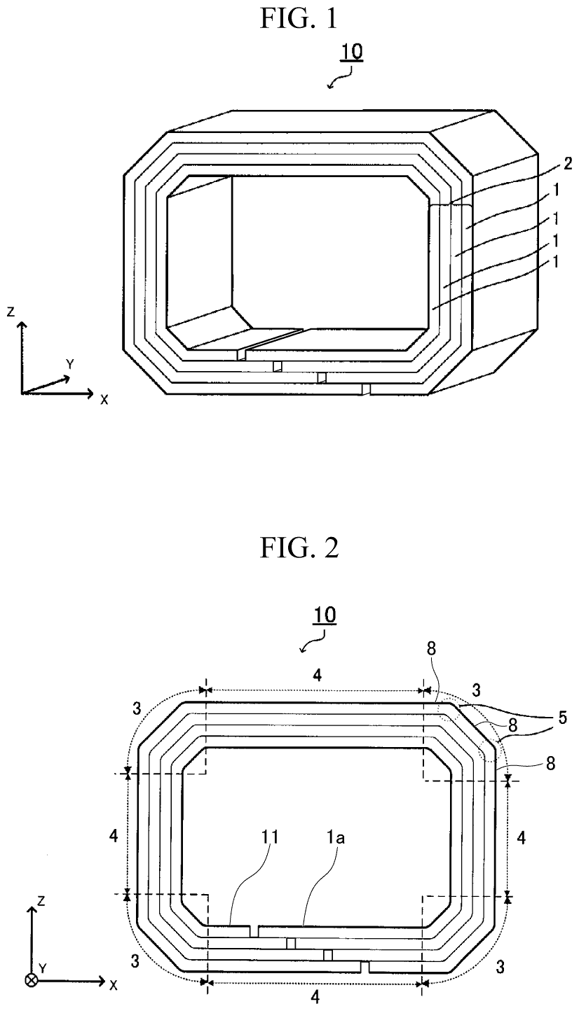

A configuration of the wound core according to the present disclosure will be described with reference to a wound core 10 in FIGS. 1 and 2 as an example. FIG. 1 is a perspective view of a wound core 10, and FIG. 2 is a side view of the wound core 10 in FIG. 1.

In the present disclosure, viewing from the side means viewing in a width direction (Y-axis direction in FIG. 1) of a grain-oriented electrical steel sheet in a long shape constituting a wound core.

The side view is a view illustrating a shape visually recognized by viewing from the side (a view in the Y-axis direction in FIG. 1). The sheet thickness direction is a sheet thickness direction of the grain-oriented electrical steel sheet. In the wound core 10 of the present disclosure, the sheet thickness direction is a direction perpendicular to the circumferential surface of the wound core in a state of being formed into a rectangular wound core.

The direction perpendicular to a circumferential surface means a direction perpendicular to the circumferential surface when the circumferential surface is viewed from the side. When the circumferential surface forms a curve in a side view, the direction perpendicular to the circumferential surface (sheet thickness direction) means a direction perpendicular to a tangent of the curve formed by the circumferential surface.

The wound core 10 is configured by laminating a plurality of bent bodies 1 in a sheet thickness direction thereof. For example, as illustrated in FIGS. 1 and 2, the wound core 10 has a substantially rectangular laminated structure including a plurality of bent bodies 1. The wound core 10 has a laminated body 2 obtained by laminating the plurality of bent bodies 1. The wound core 10 may be used as it is as a wound core. If necessary, the wound core 10 may be fixed using a fastening tool such as a known binding band. The bent body 1 is formed of a grain-oriented electrical steel sheet which is a base steel sheet. The number of bent bodies 1 (the number of laminated sheets) is not particularly limited, but for example, the number of bent bodies 1 is preferably 200 or more.

As illustrated in FIGS. 1 and 2, the wound core 10 is preferably formed in a rectangular shape by alternately continuing four flat parts 4 and four corner portions 3 along a circumferential direction. The wound core 10 has a plurality of flat parts 4 and a plurality of corner portions 3. An angle formed by two flat parts 4 adjacent to each corner portion 3 is preferably substantially 90°. Here, the circumferential direction means a direction around an axis of the wound core 10.

At the corner portion 3 of the wound core 10, the bent body 1 has two bent regions 5 (FIG. 2). The bent region 5 is a region having a curved bent shape in viewing the bent body 1 from the side. The bent region will be described in detail later. In the two bent regions 5, bending angles in total are preferably substantially 90° in viewing the bent body 1 from the side.

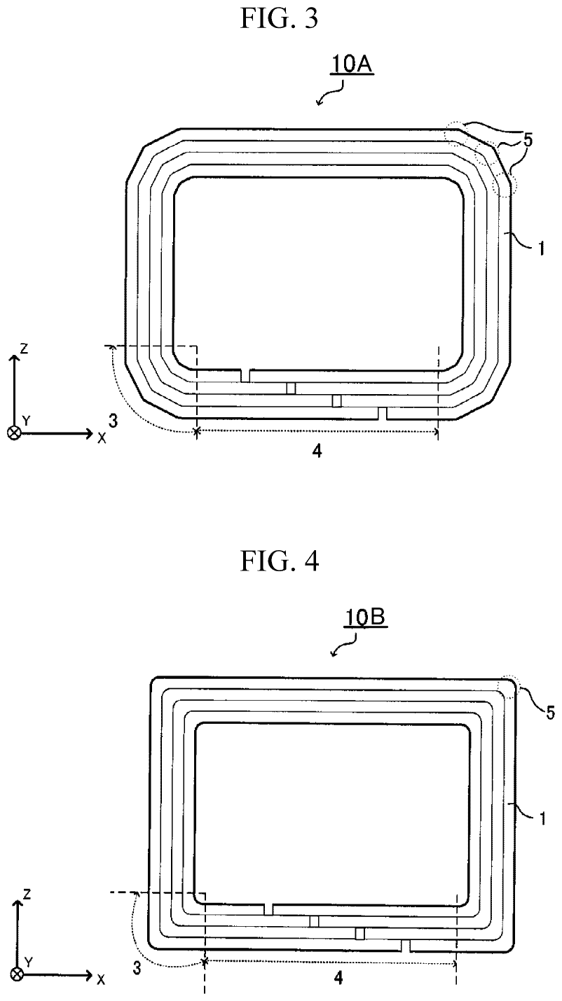

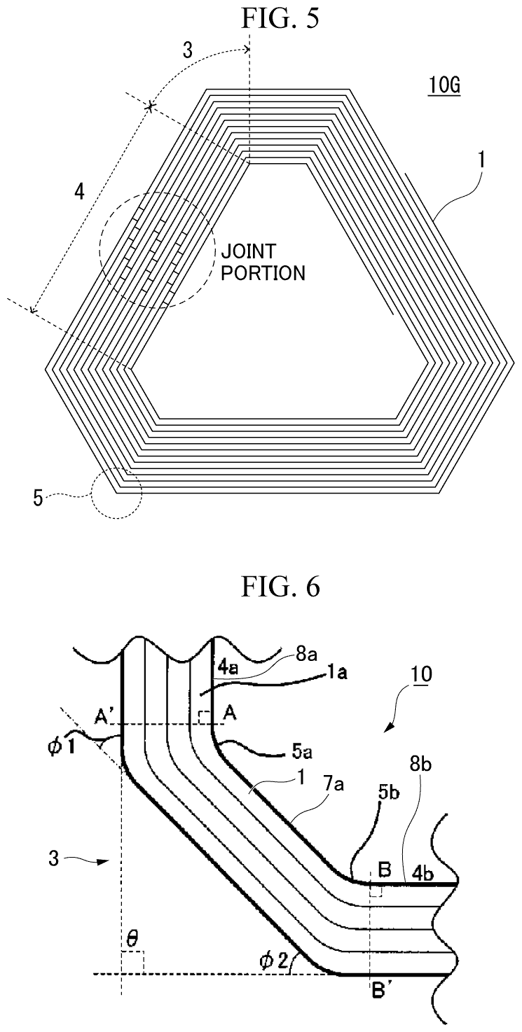

In each of the corner portions 3 of the wound core 10, the bent body 1 may have one or more bent regions 5 so that the grain-oriented electrical steel sheet is bent by substantially 90°. As in a wound core 10A according to a second aspect of the present disclosure, in each of the corner portions 3 of the wound core 10, the bent body 1 may have three bent regions 5 (FIG. 3). Also, in each of the corner portions 3 of the wound core 10, the bent body 1 may have one bent region 5 in one corner portion 3 of the wound core 10, as in a wound core 10B according to a third aspect (FIG. 4). Moreover, in each of the corner portions 3 of the wound core 10, the bent body 1 may have one bent region 5 in one corner portion 3 of the wound core 10, as in a wound core 10G according to a fourth aspect (FIG. 5). Further, as in the wound core 10G, the lengths of the flat parts 4 facing each other may be different.

### (Flat Region)

As illustrated in FIG. 2, the bent body 1 has a flat region 8 adjacent to a bent region 5. As the flat region 8 adjacent to a bent region 5, there are two flat regions 8 shown in (1A) and (1B) below.

(1A) A flat region 8 positioned between a bent region 5 and a bent region 5 (between two bent regions 5 adjacent in the circumferential direction) in one corner portion 3 and adjacent to each bent region 5 (a flat region of a corner portion).

(1B) A flat region 8 adjacent to each bent region 5 as a flat part 4.

### (Corner Portion)

FIG. 6 is an enlarged side view of the vicinity of a corner portion 3 in the wound core 10 in FIG. 1.

As illustrated in FIG. 6, in one corner portion 3, when a bent body 1a has two bent region 5a and bent region 5b, the bent region 5a (curved portion) is continuous from a flat region 8a belonging to the flat part 4 which is a flat region of the bent body 1a, and further, a flat region 7a (straight portion), the bent region 5b (curved portion), and a flat region 8b (straight portion) belonging to the flat part 4b are continuous therebeyond.

In the wound core 10, a region from a line segment A-A′ to a line segment B-B′ in FIG. 6 is the corner portion 3. A point A is an end point on the flat region 8a side in the bent region 5a of the bent body (first bent body) 1a disposed on the innermost side of the wound core 10. A point A′ is an intersection point of a straight line passing through the point A and perpendicular (sheet thickness direction) to a sheet surface of the bent body 1a and the outermost surface of the wound core 10 (an outer circumferential surface of the bent body 1 disposed on the outermost side of the wound core 10). Similarly, a point B is an end point on the flat region 8b side in the bent region 5b of the bent body 1a disposed on the innermost side of the wound core 10. A point B′ is an intersection point of a straight line passing through the point B and perpendicular (sheet thickness direction) to a sheet surface of the bent body 1a and the outermost surface of the wound core 10. In FIG. 6, an angle formed by two flat parts 4a and 4b adjacent to each other with the corner portion 3 interposed therebetween (angle formed by intersection of extension lines of the flat parts 4a and 4b) is θ, and in the example in FIG. 6, the θ is substantially 90°. The bending angles of the bent regions 5a and 5b will be described later, but in FIG. 6, the bending angles in total φ1+φ2 of the bent regions 5a and 5b are substantially 90°. The bending angle φ1 of the bent region 5a is, for example, 30° to 60°. Similarly, the bending angle φ2 of the bent region 5b is, for example, 30 to 60°. Since the bending angles φ1 and φ2 of the bent regions 5a and 5b are smaller than 90° in the deformation amount, the elastic stress due to bending, that is, bending return becomes small and the variation in angle becomes small, and thus the bending angles φ1 and φ2 of the bent regions 5a and 5b are particularly preferably 30 to 60°.

### (Bent Region)

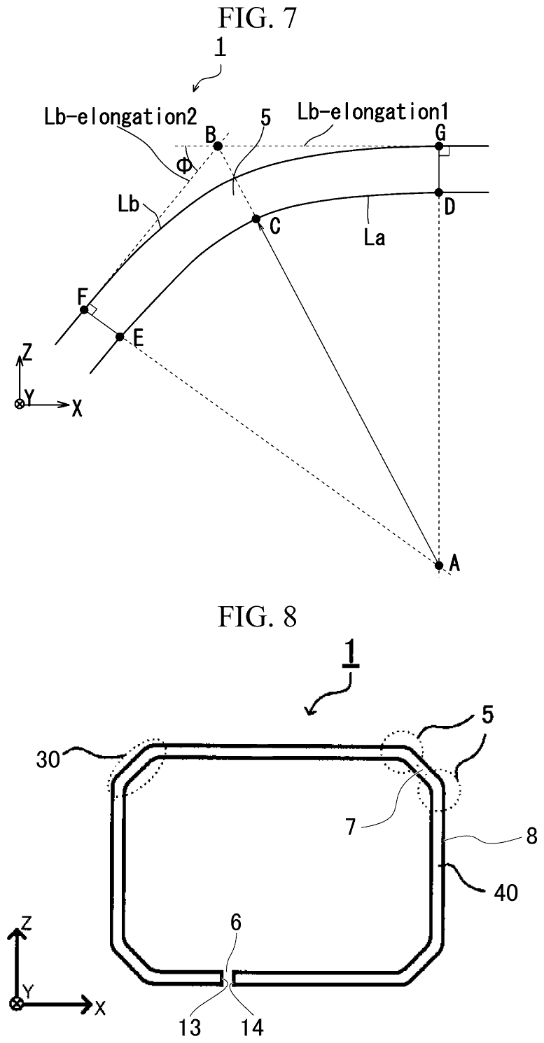

The bent region 5 will be described in detail with reference to FIG. 7. FIG. 7 is an enlarged side view of an example of the bent region 5 of the bent body 1. The bending angle q of the bent region 5 means an angular difference generated between a flat region on a rear side in a bending direction and a flat region on a front side in the bending direction in the bent region 5 of the bent body 1. Specifically, the bending angle q of the bent region 5 is represented as an angle q of a complementary angle of an angle formed by two imaginary lines Lb-elongation 1 and Lb-elongation 2 obtained by extending straight portions adjacent to respective points from points (points F and G) on both sides of a curved portion included in a line Lb representing an outer surface of the bent body 1 in the bent region 5.

The bending angle of each bent region 5 is preferably substantially 90° or less, and the bending angles in total of all the bent regions 5 of the bent body 1 existing in one corner portion 3 of the wound core 10 are substantially 90°.

In viewing the bent body 1 from the side, when points D and E on a line La representing an inner surface of the bent body 1 and the points F and G on the line Lb representing the outer surface of the bent body 1 are defined as follows, the bent region 5 indicates a region surrounded by (2A) a line delimited by the point D and the point E on the line La representing the inner surface of the bent body 1, (2B) a line delimited by the point F and the point G on the line Lb representing the outer surface of the bent body 1, (2C) a straight line connecting the point D and the point G, and (2D) a straight line connecting the point E and the point F.

Here, the point D, the point E, the point F, and the point G are defined as follows.

In viewing from the side, a point at which a straight line AB connecting a center point A of a radius of curvature in a curved portion included in the line La representing the inner surface of the bent body 1 and an intersection point B of the two imaginary lines Lb-elongation 1 and Lb-elongation 2 obtained by extending straight portions adjacent to both sides of the curved portion included in the line Lb representing the outer surface of the bent body 1 intersects the line La representing the inner surface of the bent body 1 is defined as an origin C,
a point separated from the origin C, for example, by a distance m represented by the following formula (A) in one direction along the line La representing the inner surface of the bent body 1 is defined as the point D,
a point separated from the origin C, for example, by the distance m in another direction along the line La representing the inner surface of the bent body is defined as the point E,
an intersection point between a straight portion facing the point D among the straight portions included in the line Lb representing the outer surface of the bent body and an imaginary line drawn perpendicularly to the straight portion facing the point D and passing through the point D is defined as the point G, and
an intersection point between a straight portion facing the point E among the straight portions included in the line Lb representing the outer surface of the bent body and an imaginary line drawn perpendicularly to the straight portion facing the point E and passing through the point E is defined as the point F. The intersection point A is an intersection point obtained by extending a line segment EF and a line segment DG inward on the opposite side of the point B.

$$m = r \times ( π \times φ / 180 ) \qquad ( A )$$

In formula (A), m represents a distance from the origin C, and r represents a distance (radius of curvature) from the center point A to the origin C. The radius of curvature r of the bent body 1 disposed on an inner surface side of the wound core 10 is preferably, for example, 1 mm or more and 5 mm or less. Here, the radius of curvature of the bent body 1 is the radius of curvature of the bent region 5. The radius of curvature of the bent body 1 is 5.0 mm or less. When the radius of curvature of the bent body 1 is 5.0 mm or less, noise is improved. The radius of curvature of the bent body 1 is preferably 0.1 mm or more. The radius of curvature of the bent body 1 is further preferably 0.3 mm or more. A particularly preferred radius of curvature of the bent body is 1.0 mm or more. A more preferred radius of curvature of the bent body 1 is 2.9 mm or less.

FIG. 8 is a side view of the bent body 1 of the wound core 10 in FIG. 1. As illustrated in FIG. 8, the bent body 1 is obtained by bending a grain-oriented electrical steel sheet, and has a flat region 8 and a bent region 5 adjacent to the flat region 8. The bent body 1 has a plurality of flat regions 8 and a plurality of bent regions 5. Also, the bent body 1 has four bent body corner portions 30 and four bent body flat parts 40, so that one grain-oriented electrical steel sheet forms a substantially rectangular ring in viewing from the side. More specifically, one bent body flat part 40 is provided with a gap (joint portion) 6 in which both end surfaces in the longitudinal direction of the grain-oriented electrical steel sheet face each other, and the other three bent body flat parts 40 have one or more joint portions in which the end surfaces 13 and 14 in the longitudinal direction of the bent body 1 face each other in the joint portion 6 of the bent body 1 having a structure not including the gap 6. The size of the gap of the joint portion 6 is, for example, 0.1 mm to 5.0 mm, and desirably 1.0 mm to 2.0 mm.

The wound core 10 preferably has a laminated structure having a substantially rectangular shape as a whole in viewing from the side. The wound core 10 may have a configuration in which two bent body flat parts 40 include the gap (joint portion) 6 and the other two bent body flat parts 4 do not include the gap 6. In this case, a bent body is formed of two grain-oriented electrical steel sheets.

It is desirable to prevent generation of a gap between two adjacent layers in a sheet thickness direction at the time of manufacturing the wound core. Therefore, in the two adjacent bent bodies, the length of the steel sheet and the position of the bent region are adjusted such that an outer circumferential length of a bent body flat part 40 of a bent body disposed inside is equal to an inner circumferential length of a bent body flat part 40 of a bent body disposed outside.

### (Arrangement of Joint Portions)

As illustrated in FIG. 2, when the bent body disposed on the innermost side is defined as a first bent body 1a and a flat region where the joint portion 6 of the first bent body 1a is present is defined as a reference flat region 11, a joint portion 6 of each of the plurality of bent bodies 1 is in a flat part 4 having the reference flat region 11. With such a configuration, windings can be easily assembled.

### (Distance of First-Group Joint Portion and Distance of Second-Group Joint Portion)

In the wound core 10, a joint portion 6 is arranged such that an average distance of first-group joint portions <Lᵢ> described later and an average distance of second-group joint portions <L_{O}> described later, which are present near the corner portions 3, satisfy the following expressions (1) and (2).

Plastic strain and elastic strain are introduced in the bent region 5, and strain due to shearing is introduced in an end portion of the joint portion 6. Noise is generated by extension and contraction of the grain-oriented electrical steel sheet during AC excitation. In particular, in the case of a grain-oriented electrical steel sheet into which strain is introduced, noise is significantly deteriorated. In the wound core 10, when the average distance of first-group joint portions <Lᵢ> and the average distance of second-group joint portions <L_{O}> described later satisfy the following expressions (1) and (2), the strain affected region in the bent region 5 and the shear strain affected region in the vicinity of the joint portion 6 can be densely arranged. This makes it possible to reduce the strain affected region in the entire wound core 10. As a result, noise can be reduced. The plastically deformed grain-oriented electrical steel sheet is cured by strain. Therefore, if the joint portion 6 is formed by shearing the grain-oriented electrical steel sheet near the bent region 5, burrs generated at the time of shearing may lead to coating damage of other laminated grain-oriented electrical steel sheets. In addition, even if folding is performed after shearing, shape defects of bending angle and the like occur. Furthermore, plastic strain and elastic strain interfere with strain due to shearing in the end portion of the joint portion 6 in the bent region 5, so that iron loss is further deteriorated. Therefore, <Lᵢ> is preferably 2 mm or more. In the first-group joint portion and the second-group joint portion, a joint portion with a smaller average distance is defined as the first-group joint portion.

$$2 mm \leq 〈 {L}_{i} 〉 < 25 mm \qquad ( 1 )$$

$$1.22 * 〈 Li 〉 \leq 〈 {L}_{O} 〉 \qquad ( 2 )$$

### (First-Group Joint Portion Vᵢ)

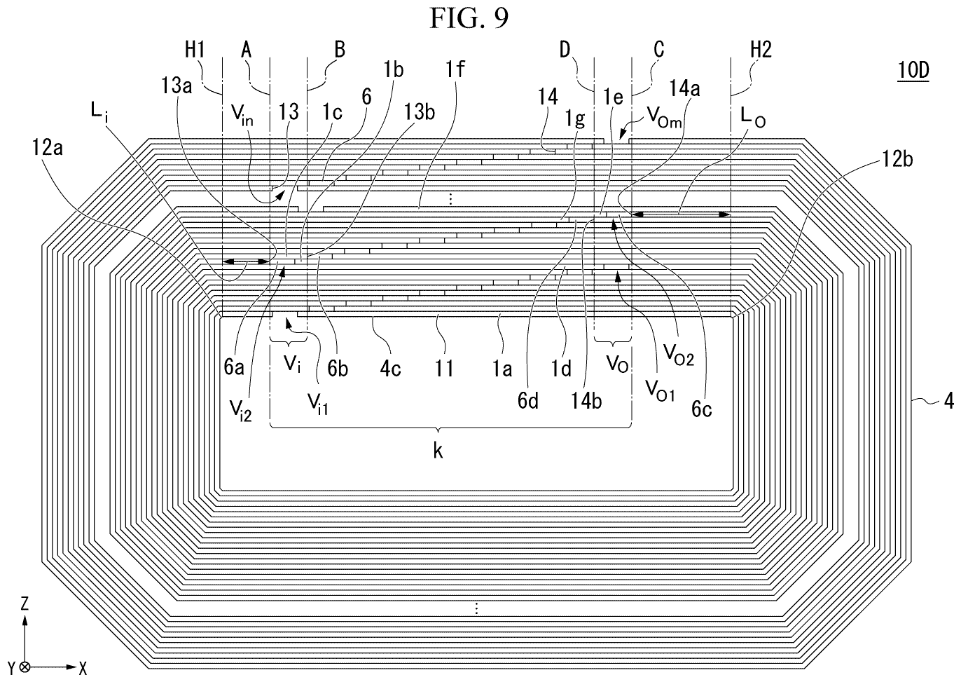

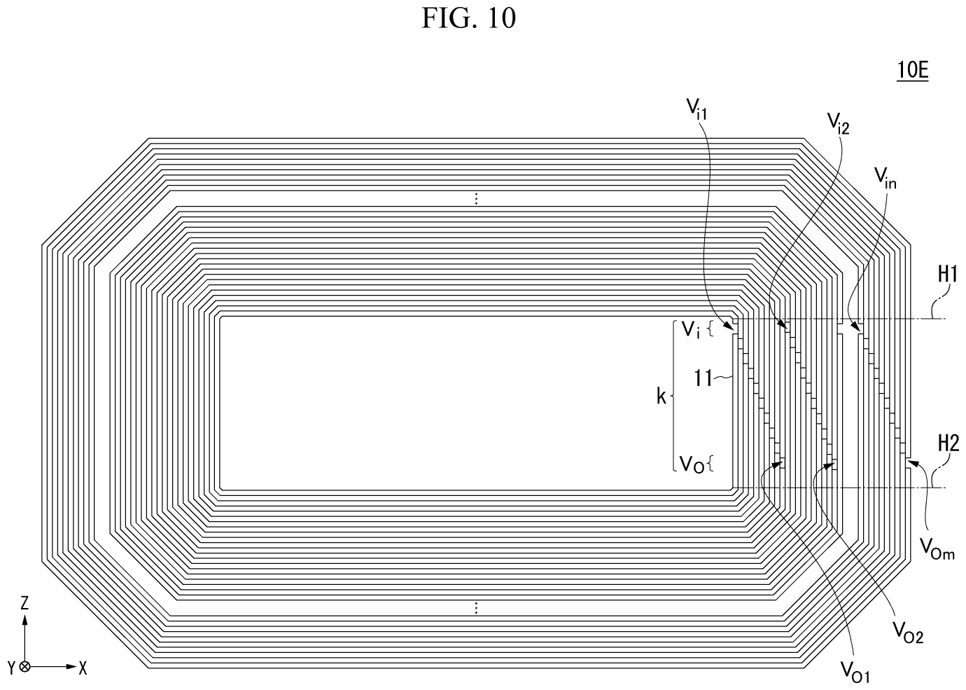

Next, a first-group joint portion Vᵢ and a second-group joint portion V_{O} will be described by taking a case where there are a plurality of first-group joint portions Vᵢ and a plurality of second-group joint portions as an example. FIG. 9 is a side view of a wound core 10D of a fifth aspect having a plurality of first-group joint portions Vᵢ and a plurality of second-group joint portions V_{O}. A plurality of bent bodies 1 are also laminated on a portion “ . . . ” between a bent body 1 and a bent body 1 of the wound core 10D in FIG. 9. The wound core 10D is a wound core in which the bent body 1 having one joint portion 6 is laminated. In FIG. 9, the bent body disposed on the innermost side is defined as a first bent body 1a, and a flat region where a joint portion 6 of the first bent body 1a is present is defined as a reference flat region 11. In the wound core 10D, each joint portion 6 is located in a flat part 4 having a reference flat region 11. In FIG. 9, the flat part 4 where the joint portion 6 is present is a flat part parallel to the X direction.

Also, one bent region adjacent to the reference flat region 11 is defined as a first bent region 12a, and the other bent region adjacent to the reference flat region 11 is defined as a second bent region 12b. An imaginary line passing through an end point of the first bent region 12a on the reference flat region 11 side and parallel to the sheet thickness direction of the reference flat region 11 is defined as a first imaginary line H1, and an imaginary line passing through an end point of the second bent region 12b on the reference flat region 11 side and parallel to the sheet thickness direction of the reference flat region 11 is defined as a second imaginary line H2.

Among the joint portions 6 of the flat part 4 having the reference flat region 11, a joint portion 6 located between the first imaginary line H1 and the second imaginary line H2 and having the shortest length from the first imaginary line H1 to the end surface 13 of the joint portion 6 on the first imaginary line H1 side along the longitudinal direction of the reference flat region 11 is defined as a first shortest joint portion 6a. Among the joint portions 6 in bent bodies 1c and 1d adjacent in the sheet thickness direction to the bent body 1b having the first shortest joint portion 6a, a joint portion 6 located between the first imaginary line H1 and the second imaginary line H2 and having a shorter length from the first imaginary line H1 to the end surface 13 of the joint portion 6 on the first imaginary line H1 side along the longitudinal direction of the reference flat region 11 is defined as a first end joint portion 6b.

An imaginary line passing through an end surface 13a of the first shortest joint portion 6a on the first imaginary line H1 side and parallel to the sheet thickness direction of the reference flat region 11 is defined as an imaginary line A. An imaginary line passing through an end surface 13b of the first end joint portion 6b on the first imaginary line H1 side and parallel to the sheet thickness direction of the reference flat region 11 is defined as an imaginary line B. Among the joint portions 6 of the flat part 4 having the reference flat region 11, a joint portion 6 located between the imaginary line A and the imaginary line B is defined as the first-group joint portion Vᵢ. Here, the number of first-group joint portions Vᵢ is n (n is a natural number) in total from Vᵢ to Vᵢₙ.

### (Average Distance of First-Group Joint Portions <Lᵢ>)

An average of lengths from the first imaginary line H1 to the end surface of each of the first-group joint portions Vᵢ on the first imaginary line H1 side along the longitudinal direction of the reference flat region 11 is defined as an average distance of first-group joint portions Vᵢ<Lᵢ>. The average distance of first-group joint portions Vᵢ <Lᵢ> can be measured by the following method. An observation image of the side surface of the wound core is obtained using an optical microscope or the like. In the obtained observation image, the first-group joint portion is specified based on the definition described above. Next, length Lᵢ from the first imaginary line H1 to the end surface of the first-group joint portion Vᵢ on the first imaginary line H1 side along the longitudinal direction of the reference flat region 11 is measured using image processing software. An average value of the obtained Lᵢ is obtained, and the average value is defined as the average distance of first-group joint portions <Lᵢ>.

### (Second-Group Joint Portion V_{O})

Next, the second-group joint portion V_{O} will be described. Among the joint portions 6 of the flat part 4 having the reference flat region 11, a joint portion located between the first imaginary line H1 and the second imaginary line H2 and having the shortest length from the second imaginary line H2 to the end surface 14 of the joint portion 6 on the second imaginary line H2 side along the longitudinal direction of the reference flat region 11 is defined as a second shortest joint portion 6c. Among the joint portions 6 in bent bodies 1f and 1g adjacent in the sheet thickness direction to the bent body 1e having the second shortest joint portion 6c, a joint portion 6 located between the first imaginary line H1 and the second imaginary line H2 and having a shorter length from the second imaginary line H2 to the end surface 14 of the joint portion 6 on the second imaginary line H2 side along the longitudinal direction of the reference flat region 11 is defined as a second end joint portion 6d.

An imaginary line passing through an end surface 14a of the second shortest joint portion 6c on the second imaginary line H2 side and parallel to the sheet thickness direction of the reference flat region 11 is defined as an imaginary line C. An imaginary line passing through an end surface 14b of the second end joint portion 6d on the second imaginary line H2 side and parallel to the sheet thickness direction of the reference flat region 11 is defined as an imaginary line D. Among the joint portions 6 of the flat part 4 having the reference flat region 11, a joint portion 6 located between the imaginary line C and the imaginary line C is defined as a second-group joint portion V_{O}. Here, the number of second-group joint portions V_{O} is m (m is a natural number) in total from V_{O1} to V_{Om}.

### (Average Distance of Second-Group Joint Portions <L_{O}>)

An average of lengths from the second imaginary line H2 to the end surface of each of the second-group joint portions V_{O} on the second imaginary line H2 side along the longitudinal direction of the reference flat region 11 is defined as an average distance of second-group joint portions V_{O}<L_{O}>. The average distance of second-group joint portions V_{O}<L_{O}> can be measured by the following method. An observation image of the side surface of the wound core is obtained using an optical microscope or the like. In the obtained observation image, the second-group joint portion V_{O} is specified based on the definition described above. Next, length L_{O} from the second imaginary line H2 to the end surface of the second-group joint portion V_{O} on the second imaginary line H2 side along the longitudinal direction of the reference flat region 11 is measured using image processing software. An average value of the obtained L_{O} is obtained, and the average value is defined as the average distance of second-group joint portions <L_{O}>.

In the wound core 10D, the joint portions 6 are preferably arranged such that the joint portions 6 are shifted from each other in a stepwise manner in the circumferential direction. In the wound core 10D, the circumferential direction is the same as the longitudinal direction of the reference flat region 11. The circumferential position of the joint portion 6 in the bent body 1 is gradually shifted from the first imaginary line H1 side (first-group joint portion Vi side) to the second imaginary line H2 side (second-group joint portion Vo side) in the circumferential direction from the bent body 1 located on the inner side in the radial direction toward the bent body 1 located on the outer side in the radial direction. The radial direction refers to a direction orthogonal to the axis of the wound core 10D. Hereinafter, such a pattern of arrangement of the joint portions 6 is referred to as a stepwise pattern. In the present embodiment, the joint portions 6 are arranged such that a plurality of stepwise patterns are repeated in the radial direction. In a first embodiment, among the joint portions 6 arranged in one stepwise pattern, a joint portion 6 of the bent body 1 located on the innermost side in the radial direction is included in the first-group joint portion Vi, and a joint portion 6 of the bent body 1 located on the outermost side in the radial direction is included in the second-group joint portion Vo. By sequentially shifting the joint portions 6 along the circumferential direction in this manner, it is possible to suppress inhibition of a flow of magnetic flux in the wound core 10D.

In the wound core 10D, the number of first-group joint portions Vᵢ is preferably equal to the number of second-group joint portions V_{O}. Also, in the wound core 10D, among a quotient and a remainder obtained by dividing the number of joint portions 6 in the flat part 4 located between the first imaginary line H1 and the second imaginary line H2 and having the reference flat region 11 by the number of first-group joint portions Vᵢ, the quotient is defined as k, and k satisfies the following expression (3). In FIG. 9, this number k is equal to the number of joint portions located between Vᵢ₁ and Vₒ₁ and located between the first imaginary line H1 and the second imaginary line H2 along the sheet thickness direction. That is, k is the number of joint portions 6 arranged to be shifted stepwise from the first-group joint portion Vᵢ to the second-group joint portion V_{O} closest to the first-group joint portion Vᵢ. The number k is the number of joint portions included in one stepwise pattern. By arranging the joint portion 6 in this manner, noise can be further suppressed.

$$9 \leq k \leq 20 \qquad ( 3 )$$

### (Length Between Imaginary Line a and Imaginary Line C)

A length between the imaginary line A and the imaginary line C along the longitudinal direction is preferably 50% or more of a length between the first imaginary line H1 and the second imaginary line H2 along the longitudinal direction. That is, (the length between the imaginary line A and the imaginary line C along the longitudinal direction)/(the length between the first imaginary line H1 and the second imaginary line H2 along the longitudinal direction)×100 is 50% or more. Since the length between the imaginary line A and the imaginary line C along the longitudinal direction is 50% or more of the length between the first imaginary line H1 and the second imaginary line H2 along the longitudinal direction, noise can be further suppressed. More preferably, the length between the imaginary line A and the imaginary line C along the longitudinal direction is 60% or more of the length between the first imaginary line H1 and the second imaginary line H2 along the longitudinal direction.

In FIG. 9, the flat part 4 where the joint portion 6 is present is a flat part parallel to the X direction, but the position of the joint portion in the present invention is not limited to the configuration of FIG. 9. For example, as in a wound core 10E of the sixth aspect in FIG. 10, the flat part 4 where the joint portion 6 is present may be a flat part parallel to the Z direction.

In the wound core 10E, the average distance of first-group joint portions Vᵢ<Lᵢ> and the average distance of second-group joint portions V_{O}<L_{O}> satisfy the above expressions (1) and (2). When the average distance of first-group joint portions <Lᵢ> and the average length <L_{O}> satisfy the above expressions (1) and (2), noise can be suppressed.

In the wound core 10E, the joint portions 6 are preferably arranged such that the joint portions 6 are shifted from each other in a stepwise manner in the circumferential direction. By sequentially shifting the joint portions 6 along the circumferential direction in this manner, it is possible to suppress inhibition of a flow of magnetic flux in the wound core 10E.

In the wound core 10E, similarly to the wound core 10D, the number of first-group joint portions Vᵢ is preferably equal to the number of second-group joint portions V_{O}. Also, in the wound core 10E, the number k obtained by dividing the number of joint portions 6 in the flat part 4 located between the first imaginary line H1 and the second imaginary line H2 and having the reference flat region 11 by the number of first-group joint portions Vᵢ satisfies the above expression (3). It is preferable that by arranging the joint portion 6 in this manner, noise can be further suppressed.

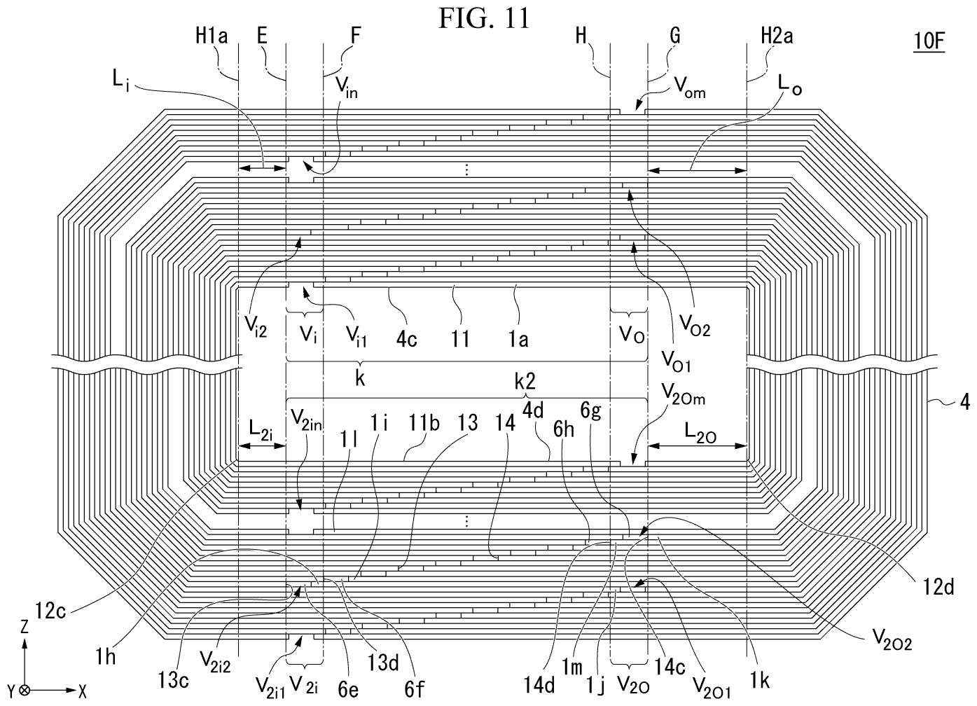

In FIGS. 9 and 10, the example of the bent body 1 having one joint portion 6 has been described, but the number of joint portions is not limited to one in the present invention. For example, as in a wound core 10F of the seventh aspect in FIG. 11, each bent body 1 may have a joint portion 6 in each of two flat regions 8 facing each other When each bent body 1 has two joint portions 6, a first bent body 1a of the wound core 10F has a reference flat region 11 and a second reference flat region 11b facing the reference flat region 11.

### (Distance of Third-Group Joint Portion and Distance of Fourth-Group Joint Portion)

In the wound core 10F, a joint portion 6 is preferably arranged such that an average distance of third-group joint portions <L₂ᵢ> described later and an average distance of fourth-group joint portions <L_{2O}> described later, which are present near the corner portions 3, satisfy the following expressions (4) and (5).

Plastic strain and elastic strain are introduced in the bent region 5, and strain due to shearing is introduced in an end portion of the joint portion 6. Noise is generated by extension and contraction of the grain-oriented electrical steel sheet during AC excitation. In particular, in the case of a grain-oriented electrical steel sheet into which strain is introduced, noise is significantly deteriorated. In the wound core 10, when the average distance of third-group joint portions <L₂ᵢ> and the average distance of fourth-group joint portions <L_{2O}> described later satisfy the following expressions (4) and (5), the strain affected region in the bent region 5 and the shear strain affected region in the vicinity of the joint portion 6 can be densely arranged. This makes it possible to further reduce the strain affected region in the entire wound core 10. As a result, noise can be further reduced. The plastically deformed grain-oriented electrical steel sheet is cured by strain. Therefore, if the joint portion 6 is formed by shearing the grain-oriented electrical steel sheet near the bent region 5, burrs generated at the time of shearing may lead to coating damage of other laminated grain-oriented electrical steel sheets. In addition, even if folding is performed after shearing, shape defects of bending angle and the like occur. Furthermore, plastic strain and elastic strain interfere with strain due to shearing in the end portion of the joint portion 6 in the bent region 5, so that iron loss is further deteriorated. Therefore, the lower limit of <L₂ᵢ> in the following expression (4) is preferably 2 mm. In the third-group joint portion and the fourth-group joint portion, a joint portion with a smaller average distance is defined as the third-group joint portion. When there are two joint portions 6 in the bent body 1 constituting the wound core and only the plurality of joint portions 6 of one flat part 4 of two flat parts 4 where the joint portions 6 are present satisfy the above expressions (1) and (2), a flat part 4 where the plurality of joint portions 6 satisfying the above expressions (1) and (2) are present is defined as a flat part 4c having the reference flat region 11.

$$2 mm \leq 〈 {L}_{2 i} 〉 < 25 mm \qquad ( 4 )$$

$$1.22 \times 〈 {L}_{2 i} 〉 \leq 〈 {L}_{2 O} 〉 \qquad ( 5 )$$

### (Third-Group Joint Portion V₂ᵢ)

Next, a third-group joint portion V₂ᵢ and a fourth-group joint portion V₂ₒ will be described by taking the wound core 10F in FIG. 11 as an example. Description of the plurality of first-group joint portions Vᵢ and the plurality of second-group joint portions V_{O} will be omitted. FIG. 11 is a side view of a wound core 10F having a plurality of third-group joint portions V₂ᵢ and a plurality of fourth-group joint portions V_{2O}. The wound core 10F is a wound core in which the bent body 1 having one joint portion 6 is laminated. In FIG. 11, the bent body disposed on the innermost side is defined as a first bent body 1a. The first bent body 1a has a reference flat region 11 and a second reference flat region 11b. The second reference flat region 11b is a flat region facing the reference flat region 11, and has a joint portion 6. The joint portion 6 of each of the plurality of bent bodies 1 is located in the flat part 4c having the reference flat region 11 and a flat part 4d having the second reference flat region 11b. In FIG. 11, the flat parts 4c and 4d where the joint portion 6 is present are flat parts parallel to the X direction.

One bent region adjacent to the second reference flat region 11b is defined as a third bent region 12c, and the other bent region adjacent to the second reference flat region 11b is defined as a fourth bent region 12d. An imaginary line passing through an end point of the third bent region 12c on the second reference flat region 11b side and parallel to the sheet thickness direction of the second reference flat region 11b is defined as a third imaginary line H1a, and an imaginary line passing through an end point of the fourth bent region 12d on the second reference flat region 11b side and parallel to the sheet thickness direction of the second reference flat region 11b is defined as a fourth imaginary line H2a.

Among the joint portions 6 of the flat part 4d having the second reference flat region 11b, a joint portion 6 located between the third imaginary line H1a and the fourth imaginary line H2a and having the shortest length from the third imaginary line H1a to the end surface 13 of the joint portion 6 on the third imaginary line H1a side along the longitudinal direction of the second reference flat region 11b is defined as a third shortest joint portion 6e. Among the joint portions 6 in bent bodies 1i and 1j adjacent in the sheet thickness direction to the bent body 1h having the third shortest joint portion 6e, a joint portion 6 located between the third imaginary line H1a and the fourth imaginary line H2a and having a shorter length from the third imaginary line H1a to the end surface 13 of the joint portion 6 on the third imaginary line H1a side along the longitudinal direction of the second reference flat region 11b is defined as a third end joint portion 6f.

An imaginary line passing through an end surface 13c of the third shortest joint portion 6e on the third imaginary line H1a side and parallel to the sheet thickness direction of the second reference flat region 11b is defined as an imaginary line E. An imaginary line passing through an end surface 13d of the third end joint portion 6f on the third imaginary line H1a side and parallel to the sheet thickness direction of the second reference flat region 11b is defined as an imaginary line F. Among the joint portions 6 of the flat part 4d having the second reference flat region 11b, a joint portion 6 located between the imaginary line E and the imaginary line F is defined as the third-group joint portion V₂ᵢ. Here, the number of third-group joint portions V₂ᵢ is n (n is a natural number) in total from V₂ᵢ to V₂ᵢₙ.

### (Average Distance of Third-Group Joint Portions <L₂ᵢ>)

An average of lengths from the third imaginary line H1a to the end surface 13 of the third-group joint portions V₂ᵢ on the third imaginary line H1a side along the longitudinal direction of the second reference flat region 11b is defined as an average distance of third-group joint portions V₂ᵢ <L₂ᵢ>. The average distance of third-group joint portions V₂ᵢ <L₂ᵢ> can be measured by the following method. An observation image of the side surface of the wound core is obtained using an optical microscope or the like. In the obtained observation image, the third-group joint portion is specified based on the definition described above. Next, length L₂ᵢ from the third imaginary line H1a to the end surface 13 of the third-group joint portion V₂ᵢ on the third imaginary line H1a side along the longitudinal direction of the second reference flat region 11b (flat region facing the first reference flat region) is measured using image processing software. An average value of the obtained Lᵢ is obtained, and the average value is defined as the average distance of third-group joint portions <L₂ᵢ>.

### (Fourth-Group Joint Portion V₂o)

Next, the fourth-group joint portion V₂o will be described. Among the joint portions 6 of the flat part 4d having the second reference flat region 11b, a joint portion 6 located between the third imaginary line H1a and the fourth imaginary line H2a and having the shortest length from the fourth imaginary line H2a to the end surface 14 of the joint portion 6 on the fourth imaginary line H2a side along the longitudinal direction of the second reference flat region 11b is defined as a fourth shortest joint portion 6g. Among the joint portions 6 in bent bodies 1l and 1m adjacent in the sheet thickness direction to the bent body 1k having the fourth shortest joint portion 6g, a joint portion 6 located between the third imaginary line H1a and the fourth imaginary line H2a and having a shorter length from the fourth imaginary line H2a to the end surface 14 of the joint portion 6 on the fourth imaginary line H2a side along the longitudinal direction of the second reference flat region 11b is defined as a fourth end joint portion 6h.

An imaginary line passing through an end surface 14c of the fourth shortest joint portion 6g on the fourth imaginary line H2a side and parallel to the sheet thickness direction of the second reference flat region 11b is defined as an imaginary line G. An imaginary line passing through an end surface 14d of the fourth end joint portion 6h on the fourth imaginary line H2a side and parallel to the sheet thickness direction of the second reference flat region 11b is defined as an imaginary line H. Among the joint portions 6 of the flat part 4d having the second reference flat region 11b, a joint portion 6 located between the imaginary line G and the imaginary line H is defined as the fourth-group joint portion V_{2O}. Here, the number of fourth-group joint portions V_{2O} is m (m is a natural number) in total from V_{2Ol} to V_{2Om}.

### (Average Distance of Fourth-Group Joint Portions <L_{2O}>)

An average of lengths from the fourth imaginary line H2a to the end surface 14 of the fourth-group joint portions V_{2O} on the fourth imaginary line H2a side along the Longitudinal direction of the second reference flat region 11b is defined as an average distance of fourth-group joint portions V₂ₒ <L_{2O}>. The average distance of fourth-group joint portions V₂ₒ <L_{O}> can be measured by the following method. An observation image of the side surface of the wound core is obtained using an optical microscope or the like. In the obtained observation image, the fourth-group joint portion V₂ₒ is specified based on the definition described above. Next, length L_{2O} from the fourth imaginary line H2a to the end surface of the fourth-group joint portion V_{2O} on the fourth imaginary line H2a side along the longitudinal direction of the second reference flat region 11b is measured using image processing software. An average value of the obtained L_{2O} is obtained, and the average value is defined as the average distance of fourth-group joint portions <L_{2O}>.

In the wound core 10F, the joint portions 6 are preferably arranged such that the joint portions 6 are shifted from each other in a stepwise manner in the circumferential direction. The circumferential position of the joint portion 6 in the bent body 1 is gradually shifted from the third imaginary line H1a side (first-group joint portion Vi side) to the fourth imaginary line H2a side (second-group joint portion Vo side) in the circumferential direction from the bent body 1 located on the inner side in the radial direction toward the bent body 1 located on the outer side in the radial direction. In the flat part 4d, the joint portions 6 are arranged such that a plurality of stepwise patterns are repeated in the radial direction. In the wound core 10F, among the joint portions 6 arranged in one stepwise pattern, a joint portion 6 of the bent body 1 located on the innermost side in the radial direction is included in the third-group joint portion V₂ᵢ, and a joint portion 6 of the bent body 1 located on the outermost side in the radial direction is included in the fourth-group joint portion V₂ₒ. By sequentially shifting the joint portions 6 along the circumferential direction in this manner, it is possible to suppress inhibition of a flow of magnetic flux in the wound core 10F.

In the wound core 10F, the number of third-group joint portions V₂ᵢ is preferably equal to the number of fourth-group joint portions V₂o. Also, in the wound core 10F, among a second quotient and a second remainder obtained by dividing the number of joint portions 6 in the flat part 4d located between the third imaginary line H1a and the fourth imaginary line H2a and having the second reference flat region 11b by the number of third-group joint portions V₂ᵢ, the second quotient is defined as k2, and k2 satisfies the following expression (6). In FIG. 11, the number k2 is equal to the number of joint portions located between V₂ᵢ₁ and V₂ₒ₁ and located between the third imaginary line H1a and the fourth imaginary line H2a along the sheet thickness direction. That is, k2 is the number of joint portions 6 arranged to be shifted stepwise from the specific third-group joint portion V₂ᵢ to the fourth-group joint portion V₂ₒ closest to the third-group joint portion V₂ᵢ. The number k2 is the number of joint portions included in one stepwise pattern. By arranging the joint portion 6 in this manner, noise can be further suppressed.

$$9 \leq k 2 \leq 20 \qquad ( 6 )$$

### <Wound Core Manufacturing Method>

Next, the wound core manufacturing method of the present disclosure will be described. Also, a method of manufacturing the grain-oriented electrical steel sheet constituting the bent body 1 is not particularly limited, and a method of manufacturing a conventionally known grain-oriented electrical steel sheet can be appropriately selected. Preferred specific examples of the manufacturing method include a method in which a slab having a chemical composition of the grain-oriented electrical steel sheet is heated to 1000° C. or higher to perform hot rolling, and then hot-band annealing is performed as necessary, then cold rolling is performed once or twice or more with intermediate annealing interposed therebetween to obtain a cold-rolled steel sheet, and the cold-rolled steel sheet is heated to 700 to 900° C. in, for example, a wet hydrogen-inert gas atmosphere to perform decarburization annealing, nitriding annealing is further performed as necessary, an annealing separator is applied, then final annealing is performed at about 1000° C., and thus an insulating coating is formed at about 900° C. Thereafter, coating or the like may be further performed for adjusting the dynamic friction coefficient.

In the wound core manufacturing method of the present disclosure, the wound core 10 including the grain-oriented electrical steel sheets each having the above-described form is manufactured by shearing, folding, and laminating the grain-oriented electrical steel sheets in the sheet thickness direction such that the average distance of first-group joint portions Vᵢ<Lᵢ> satisfies the above expression (1) and the average distance of second-group joint portions V_{O}<L_{O}> satisfies the above expression (2) when the bent body 1 has one joint portion 6. Also, when there are two joint portions 6 in the bent body 1, it is preferable that the grain-oriented electrical steel sheets are sheared, folded, and laminated in the sheet thickness direction such that the average distance of first-group joint portions Vᵢ<Lᵢ> satisfies the above expression (1), the average distance of second-group joint portions V_{O}<L_{O}> satisfies the above expression (2), and the average distance of third-group joint portions V₂ᵢ <L₂ᵢ> and the average distance of fourth-group joint portions V₂ₒ <L_{2O}> satisfy the above expressions (4) and (5). Each winding is assembled such that the end surfaces of the grain-oriented electrical steel sheets face each other via at least one joint portion 6. The manufacturing method of the present disclosure manufactures a wound core satisfying the above conditions by adjusting a feed amount of the grain-oriented electrical steel sheet, a bending timing, and a shearing timing of the grain-oriented electrical steel sheet.

### (Wound Core Manufacturing Apparatus)

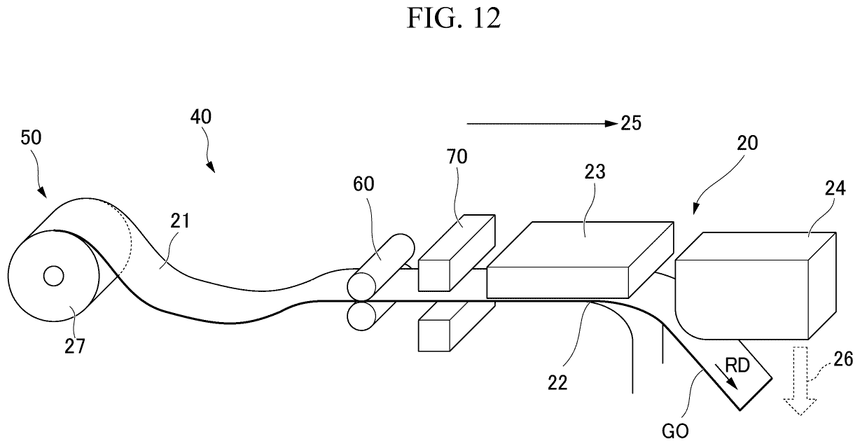

Next, a wound core manufacturing apparatus according to the present disclosure will be described. The following manufacturing apparatus is an example of a manufacturing apparatus for manufacturing the wound core 10 of the present disclosure. As illustrated in FIG. 12, a wound core manufacturing apparatus 40 is a manufacturing apparatus 40 of the wound core 10 formed by bending and laminating steel sheets (grain-oriented electrical steel sheets) 21. The wound core manufacturing apparatus 40 includes a bending device 20 that bends the grain-oriented electrical steel sheet 21 and a feed roll 60 that feeds the grain-oriented electrical steel sheet 21 to the bending device 20. The wound core manufacturing apparatus 40 of the present disclosure may include a decoiler 50 and a cutting device 70.

### “Decoiler”

The decoiler 50 unwinds the grain-oriented electrical steel sheet 21 from a coil 27 of the grain-oriented electrical steel sheet 21. The grain-oriented electrical steel sheet 21 unwound from the decoiler 50 is conveyed toward the feed roll 60.

### “Feed Roll”

The feed roll 60 conveys the grain-oriented electrical steel sheet 21 to the bending device 20. The feed roll 60 adjusts a conveyance direction 25 of the grain-oriented electrical steel sheet 21 immediately before being supplied into the bending device 20. The feed roll 60 adjusts the conveyance direction 25 of the grain-oriented electrical steel sheet 21 in a horizontal direction, and then supplies the grain-oriented electrical steel sheet 21 to the bending device 20.

The cutting device 70 is installed between the feed roll 60 and the bending device 20. The grain-oriented electrical steel sheet 21 is cut by the cutting device 70, and then bent. The cutting method is not particularly limited. The cutting method is, for example, shearing.

### “Bending Device”

The bending device 20 bends the grain-oriented electrical steel sheet 21 conveyed from the feed roll 30. A bent body 1 has a bent region obtained by bending and a flat region adjacent to the bent region. In the bent body 1, a bent body flat part and a bent body corner portion are alternately continuous. In each corner portion, an angle formed by two adjacent flat parts is preferably substantially 90°.

The bending device 20 includes, for example, a die 22 and a punch 24 for press working. The bending device further includes a guide 23 for fixing the grain-oriented electrical steel sheet 21 and a cover (not illustrated). The cover covers the die 22, the punch 24, and the guide 23. After the bending device 20 bends the grain-oriented electrical steel sheet 21, the grain-oriented electrical steel sheet 21 may be cut by the cutting device 70. After the cutting device 70 cuts the grain-oriented electrical steel sheet 21, the bending device 20 may perform bending.

The grain-oriented electrical steel sheet 21 is conveyed in the conveyance direction 25 and fixed at a position set in advance. Next, the punch 24 pressurizes up to a predetermined position in a pressurization direction 26 with a predetermined force set in advance, so that the bent body 1 having a bent region of a desired bending angle φ is obtained.

### “Lamination”

By the bending device 20, the bent bodies 1 are laminated in a sheet thickness direction. The bent bodies 1 are laminated by aligning bent body corner portions 3 and being overlapped in a sheet thickness direction to form, for example, a laminated body 2 having a substantially rectangular shape in viewing from the side. As a result, it is possible to obtain the low-noise wound core according to the present disclosure. When the number of joint portions 6 of the bent body 1 is one, the bent bodies 1 are laminated in the sheet thickness direction by the bending device 20 such that the average distance of first-group joint portions Vᵢ<Lᵢ> and the average distance of second-group joint portions V_{O}<L_{O}> satisfy the above expressions (1) and (2). When there are two joint portions 6 in the bent body 1, it is preferable to laminate the bent bodies 1 in the sheet thickness direction such that the average distance of first-group joint portions Vᵢ<Lᵢ> and the average distance of second-group joint portions V_{O}<L_{O}> satisfy the above expressions (1) and (2), and the average distance of third-group joint portions V₂ᵢ <L₂ᵢ> and the average distance of fourth-group joint portions V₂ₒ<L_{2O}> satisfy the above expressions (4) and (5). The obtained wound core may be further fixed using a known binding band or fastening tool as necessary.

The present disclosure is not limited to the above embodiments. The above embodiments are examples, and anything having substantially the identical configuration as the technical idea described in the claims of the present disclosure and exhibiting the same operation and effects is included in the technical scope of the present disclosure. The wound core manufacturing method of the present disclosure manufactures a wound core using the above wound core manufacturing apparatus.

### EXAMPLES

Hereinafter, examples (experimental examples) will be described, but the wound core according to the present disclosure is not limited to the following examples. The wound core of the present disclosure can adopt various conditions as long as the object of the present disclosure is achieved without departing from the gist of the present disclosure. The conditions in the following examples are condition examples adopted to confirm the operability and effects.

### Experimental Example 1

### [Manufacture of Wound Core]

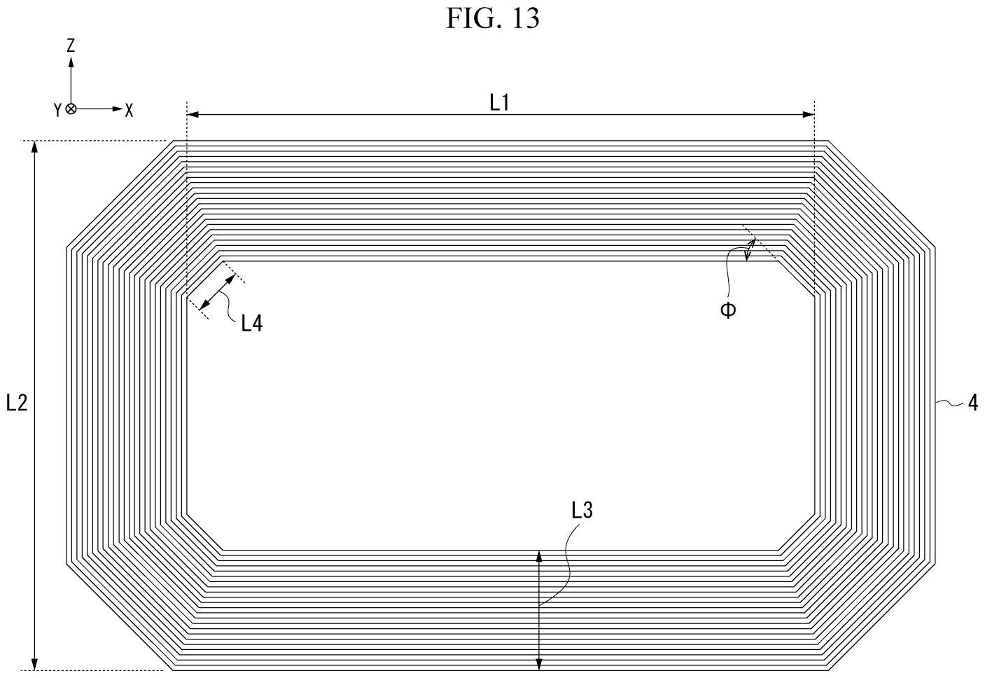

Grain-oriented electrical steel sheets having sheet thicknesses in Tables 1A to 1J (sheet width: 152.4 mm, sheet thickness: 0.23 mm or 0.18 mm, Si content: 3.45 mass %) were sheared and bent so that the average distance of first-group joint portions Vᵢ<Lᵢ>, the average distance of second-group joint portions V_{O}<L_{O}>, the average distance of third-group joint portions V₂ᵢ <L₂ᵢ>, the average distance of fourth-group joint portions V₂ₒ<L_{2O}>, the number k, and the number k2 in Tables 2A to 2J were obtained to prepare bent bodies, and the bent bodies were laminated in the sheet thickness direction to obtain a wound core having dimensions shown in FIG. 13. The bending angle φ of the wound core was set to 45°. L1 is a length of a flat part parallel to the X-axis direction. L2 is a length of a flat part parallel to the Z-axis direction. L3 is a winding thickness (thickness in the laminating direction) of the wound core. L4 is a circumferential length of a flat region of the innermost circumference at the corner portion of the wound core. In each example, L1: 344 mm, L2: 122 mm, L3: 94.1 mm, and LA: 4 mm were set. Also, the radius of curvature in each bent region was set to 1.5 mm. Although the joint portions are omitted in FIG. 13, the joint portions of each example were formed in the above-described stepwise pattern. A wound core having one joint portion was defined as a core A, and a wound core having two joint portions was defined as a core B. Two joint portions of each bent body of the core B are in two flat regions facing each other. In Tables 2A to 2J, the column of joint portion 1 means a joint portion of a flat part having a reference flat region, and a joint portion 2 means a joint portion of a flat part having a second reference flat region. When each of the two flat parts had a joint portion, and only a plurality of joint portions of one flat part satisfied the conditions of the average distance of the above expressions (1) and (2), the joint portion of the flat part satisfying the conditions of the average distance of the above expressions (1) and (2) was defined as the joint portion 1.

### [Evaluation of Noise]

In noise measurement, the wound cores of Experiment Nos. 1 to 238 in Tables 1A to 1J were prepared and excited, and the noise measurement was performed. This noise measurement was performed in an anechoic chamber with a background noise of 16 dBA with a noise meter installed at a position of 0.3 m from the core surface using an A-weighted network. In the excitation, the frequency was set to 50 Hz, and the magnetic flux density was set to 1.7 T. A core noise of 45 dBA or less was regarded as acceptable.

TABLE 1A

| | | | | Number |
|---|---|---|---|---|
| | | | | of |
| | | Material sheet | Winding | laminated |
| Experiment | Core | thickness | thickness | sheets |
| No. | type | (mm) | (mm) | (sheets) |
| 1 | A | 0.23 | 94.1 | 418 |
| 2 | A | 0.23 | 94.1 | 418 |
| 3 | A | 0.23 | 94.1 | 418 |
| 4 | A | 0.23 | 94.1 | 418 |
| 5 | A | 0.23 | 94.1 | 418 |
| 6 | A | 0.23 | 94.1 | 418 |
| 7 | A | 0.23 | 94.1 | 418 |
| 8 | A | 0.23 | 94.1 | 418 |
| 9 | A | 0.23 | 94.1 | 418 |
| 10 | A | 0.23 | 94.1 | 418 |
| 11 | A | 0.23 | 94.1 | 418 |
| 12 | A | 0.23 | 94.1 | 418 |
| 13 | A | 0.23 | 94.1 | 418 |
| 14 | A | 0.23 | 94.1 | 418 |
| 15 | A | 0.23 | 94.1 | 418 |
| 16 | A | 0.23 | 94.1 | 418 |
| 17 | A | 0.23 | 94.1 | 418 |
| 18 | A | 0.23 | 94.1 | 418 |
| 19 | A | 0.23 | 94.1 | 418 |
| 20 | A | 0.23 | 94.1 | 418 |
| 21 | A | 0.23 | 94.1 | 418 |
| 22 | A | 0.23 | 94.1 | 418 |
| 23 | A | 0.23 | 94.1 | 418 |
| 24 | A | 0.23 | 94.1 | 418 |
| 25 | A | 0.23 | 94.1 | 418 |

TABLE 1B

| | | | | Number |
|---|---|---|---|---|
| | | | | of |
| | | Material sheet | Winding | laminated |
| Experiment | Core | thickness | thickness | sheets |
| No. | type | (mm) | (mm) | (sheets) |
| 26 | A | 0.23 | 94.1 | 418 |
| 27 | A | 0.23 | 94.1 | 418 |
| 28 | A | 0.23 | 94.1 | 418 |
| 29 | A | 0.23 | 94.1 | 418 |
| 30 | A | 0.23 | 94.1 | 418 |
| 31 | A | 0.23 | 94.1 | 418 |
| 32 | A | 0.23 | 94.1 | 418 |
| 33 | A | 0.23 | 94.1 | 418 |
| 34 | A | 0.23 | 94.1 | 418 |
| 35 | A | 0.23 | 94.1 | 418 |
| 36 | A | 0.23 | 94.1 | 418 |
| 37 | A | 0.23 | 94.1 | 418 |
| 38 | A | 0.23 | 94.1 | 418 |
| 39 | A | 0.23 | 94.1 | 418 |
| 40 | A | 0.23 | 94.1 | 418 |
| 41 | A | 0.23 | 94.1 | 418 |
| 42 | A | 0.23 | 94.1 | 418 |
| 43 | A | 0.23 | 94.1 | 418 |
| 44 | A | 0.23 | 94.1 | 418 |
| 45 | A | 0.23 | 94.1 | 418 |
| 46 | A | 0.23 | 94.1 | 418 |
| 47 | A | 0.23 | 94.1 | 418 |
| 48 | A | 0.23 | 94.1 | 415 |
| 49 | A | 0.23 | 94.1 | 416 |
| 50 | A | 0.23 | 94.1 | 417 |

TABLE 1C

| | | | | Number |
|---|---|---|---|---|
| | | | | of |
| | | Material sheet | Winding | laminated |
| Experiment | Core | thickness | thickness | sheets |
| No. | type | (mm) | (mm) | (sheets) |
| 51 | A | 0.23 | 94.1 | 419 |
| 52 | A | 0.23 | 94.1 | 420 |
| 53 | A | 0.23 | 94.1 | 414 |
| 54 | A | 0.23 | 94.1 | 418 |
| 55 | A | 0.23 | 94.1 | 418 |
| 56 | A | 0.23 | 94.1 | 418 |
| 57 | A | 0.23 | 94.1 | 418 |
| 58 | A | 0.23 | 94.1 | 418 |
| 59 | A | 0.23 | 94.1 | 418 |
| 60 | A | 0.23 | 94.1 | 418 |
| 61 | A | 0.23 | 94.1 | 418 |
| 62 | A | 0.23 | 94.1 | 418 |
| 63 | A | 0.23 | 94.1 | 418 |
| 64 | A | 0.23 | 94.1 | 418 |
| 65 | A | 0.23 | 94.1 | 414 |
| 66 | A | 0.23 | 94.1 | 415 |
| 67 | A | 0.23 | 94.1 | 417 |
| 68 | A | 0.23 | 94.1 | 419 |
| 69 | A | 0.23 | 94.1 | 420 |
| 70 | A | 0.23 | 94.1 | 422 |
| 71 | A | 0.23 | 94.1 | 418 |
| 72 | A | 0.23 | 94.1 | 418 |
| 73 | A | 0.23 | 94.1 | 418 |
| 74 | A | 0.23 | 94.1 | 418 |
| 75 | A | 0.23 | 94.1 | 418 |

TABLE 1D

| | | | | Number |
|---|---|---|---|---|
| | | | | of |
| | | Material sheet | Winding | laminated |
| Experiment | Core | thickness | thickness | sheets |
| No. | type | (mm) | (mm) | (sheets) |
| 76 | A | 0.23 | 94.1 | 418 |
| 77 | A | 0.23 | 94.1 | 418 |
| 78 | A | 0.23 | 94.1 | 418 |
| 79 | A | 0.23 | 94.1 | 418 |
| 80 | A | 0.23 | 94.1 | 418 |
| 81 | A | 0.23 | 94.1 | 422 |
| 82 | A | 0.23 | 94.1 | 416 |
| 83 | A | 0.23 | 94.1 | 418 |
| 84 | A | 0.23 | 94.1 | 418 |
| 85 | A | 0.23 | 94.1 | 418 |
| 86 | A | 0.23 | 94.1 | 418 |
| 87 | A | 0.23 | 94.1 | 418 |
| 88 | A | 0.23 | 94.1 | 418 |
| 89 | A | 0.23 | 94.1 | 418 |
| 90 | A | 0.23 | 94.1 | 418 |
| 91 | A | 0.23 | 94.1 | 418 |
| 92 | A | 0.23 | 94.1 | 418 |
| 93 | A | 0.23 | 94.1 | 418 |
| 94 | A | 0.23 | 94.1 | 418 |
| 95 | A | 0.23 | 94.1 | 418 |
| 96 | A | 0.23 | 94.1 | 418 |
| 97 | A | 0.23 | 94.1 | 418 |
| 98 | A | 0.23 | 94.1 | 418 |
| 99 | A | 0.23 | 94.1 | 418 |
| 100 | A | 0.23 | 94.1 | 418 |

TABLE 1E

| | | | | Number |
|---|---|---|---|---|
| | | | | of |
| | | Material sheet | Winding | laminated |
| Experiment | Core | thickness | thickness | sheets |
| No. | type | (mm) | (mm) | (sheets) |
| 101 | A | 0.23 | 94.1 | 418 |
| 102 | A | 0.23 | 94.1 | 418 |
| 103 | A | 0.23 | 94.1 | 418 |
| 104 | A | 0.23 | 94.1 | 418 |
| 105 | A | 0.23 | 94.1 | 418 |
| 106 | A | 0.23 | 94.1 | 418 |
| 107 | A | 0.23 | 94.1 | 418 |
| 108 | A | 0.23 | 94.1 | 418 |
| 109 | A | 0.23 | 94.1 | 418 |
| 110 | A | 0.23 | 94.1 | 418 |
| 111 | A | 0.23 | 94.1 | 418 |
| 112 | A | 0.23 | 94.1 | 418 |
| 113 | A | 0.23 | 94.1 | 418 |
| 114 | A | 0.23 | 94.1 | 418 |
| 115 | A | 0.23 | 94.1 | 418 |
| 116 | A | 0.23 | 94.1 | 418 |
| 117 | A | 0.23 | 94.1 | 418 |
| 118 | A | 0.23 | 94.1 | 418 |
| 119 | A | 0.23 | 94.1 | 418 |
| 120 | A | 0.23 | 94.1 | 418 |
| 121 | A | 0.23 | 94.1 | 418 |
| 122 | A | 0.23 | 94.1 | 418 |
| 123 | A | 0.23 | 94.1 | 418 |
| 124 | A | 0.23 | 94.1 | 418 |
| 125 | A | 0.23 | 94.1 | 418 |

TABLE 1F

| | | | | Number |
|---|---|---|---|---|
| | | | | of |
| | | Material sheet | Winding | laminated |
| Experiment | Core | thickness | thickness | sheets |
| No. | type | (mm) | (mm) | (sheets) |
| 126 | A | 0.23 | 94.1 | 418 |
| 127 | A | 0.23 | 94.1 | 418 |
| 128 | A | 0.23 | 94.1 | 418 |
| 129 | A | 0.23 | 94.1 | 418 |
| 130 | A | 0.23 | 94.1 | 418 |
| 131 | A | 0.23 | 94.1 | 418 |
| 132 | A | 0.23 | 94.1 | 418 |
| 133 | A | 0.23 | 94.1 | 418 |
| 134 | A | 0.23 | 94.1 | 418 |
| 135 | A | 0.23 | 94.1 | 418 |
| 136 | A | 0.23 | 94.1 | 418 |
| 137 | A | 0.23 | 94.1 | 418 |
| 138 | A | 0.23 | 94.1 | 418 |
| 139 | A | 0.23 | 94.1 | 418 |
| 140 | A | 0.23 | 94.1 | 418 |
| 141 | A | 0.23 | 94.1 | 418 |
| 142 | A | 0.23 | 94.1 | 418 |
| 143 | A | 0.23 | 94.1 | 418 |
| 144 | A | 0.23 | 94.1 | 418 |
| 145 | A | 0.23 | 94.1 | 418 |
| 146 | A | 0.23 | 94.1 | 418 |
| 147 | A | 0.23 | 94.1 | 418 |
| 148 | A | 0.23 | 94.1 | 418 |
| 149 | A | 0.23 | 94.1 | 418 |
| 150 | A | 0.23 | 94.1 | 418 |

TABLE 1G

| | | | | Number |
|---|---|---|---|---|
| | | | | of |
| | | Material sheet | Winding | laminated |
| Experiment | Core | thickness | thickness | sheets |
| No. | type | (mm) | (mm) | (sheets) |
| 151 | A | 0.23 | 94.1 | 418 |
| 152 | A | 0.23 | 94.1 | 418 |
| 153 | A | 0.23 | 94.1 | 418 |
| 154 | A | 0.23 | 94.1 | 418 |
| 155 | A | 0.23 | 94.1 | 418 |
| 156 | A | 0.23 | 94.1 | 418 |
| 157 | A | 0.23 | 94.1 | 418 |
| 158 | A | 0.23 | 94.1 | 418 |
| 159 | A | 0.23 | 94.1 | 418 |
| 160 | A | 0.23 | 94.1 | 418 |
| 161 | A | 0.23 | 94.1 | 418 |
| 162 | A | 0.23 | 94.1 | 418 |
| 163 | A | 0.23 | 94.1 | 418 |
| 164 | A | 0.23 | 94.1 | 418 |
| 165 | A | 0.23 | 94.1 | 418 |
| 166 | A | 0.23 | 94.1 | 418 |
| 167 | A | 0.23 | 94.1 | 418 |
| 168 | A | 0.23 | 94.1 | 418 |
| 169 | A | 0.23 | 94.1 | 418 |
| 170 | A | 0.23 | 94.1 | 418 |
| 171 | A | 0.23 | 94.1 | 418 |
| 172 | A | 0.23 | 94.1 | 418 |
| 173 | A | 0.23 | 94.1 | 418 |
| 174 | A | 0.23 | 94.1 | 418 |
| 175 | A | 0.23 | 94.1 | 418 |

TABLE 1H

| | | | | Number |
|---|---|---|---|---|
| | | | | of |
| | | Material sheet | Winding | laminated |
| Experiment | Core | thickness | thickness | sheets |
| No. | type | (mm) | (mm) | (sheets) |
| 176 | A | 0.23 | 94.1 | 418 |
| 177 | A | 0.23 | 94.1 | 418 |
| 178 | A | 0.23 | 94.1 | 418 |
| 179 | A | 0.23 | 94.1 | 418 |
| 180 | A | 0.23 | 94.1 | 418 |
| 181 | A | 0.23 | 94.1 | 418 |
| 182 | A | 0.23 | 94.1 | 418 |
| 183 | A | 0.23 | 94.1 | 418 |
| 184 | A | 0.23 | 94.1 | 418 |
| 185 | A | 0.23 | 94.1 | 418 |
| 186 | A | 0.23 | 94.1 | 418 |
| 187 | A | 0.23 | 94.1 | 418 |
| 188 | A | 0.23 | 94.1 | 418 |
| 189 | A | 0.23 | 94.1 | 418 |
| 190 | A | 0.23 | 94.1 | 418 |
| 191 | A | 0.23 | 94.1 | 418 |
| 192 | A | 0.23 | 94.1 | 418 |
| 193 | A | 0.23 | 94.1 | 418 |
| 194 | A | 0.23 | 94.1 | 418 |
| 195 | B | 0.23 | 94.1 | 418 |
| 196 | B | 0.23 | 94.1 | 418 |
| 197 | B | 0.23 | 94.1 | 418 |
| 198 | B | 0.23 | 94.1 | 422 |
| 199 | B | 0.23 | 94.1 | 425 |
| 200 | B | 0.23 | 94.1 | 417 |

TABLE 1I

| | | | | Number |
|---|---|---|---|---|
| | | | | of |
| | | Material sheet | Winding | laminated |
| Experiment | Core | thickness | thickness | sheets |
| No. | type | (mm) | (mm) | (sheets) |
| 201 | B | 0.23 | 94.1 | 418 |
| 202 | B | 0.23 | 94.1 | 418 |
| 203 | B | 0.23 | 94.1 | 418 |
| 204 | B | 0.23 | 94.1 | 418 |
| 205 | B | 0.23 | 94.1 | 418 |
| 206 | B | 0.23 | 94.1 | 418 |
| 207 | A | 0.18 | 94.1 | 418 |
| 208 | A | 0.18 | 94.1 | 418 |
| 209 | A | 0.18 | 94.1 | 418 |
| 210 | A | 0.18 | 94.1 | 418 |
| 211 | A | 0.18 | 94.1 | 418 |
| 212 | A | 0.18 | 94.1 | 418 |
| 213 | A | 0.18 | 94.1 | 418 |
| 214 | A | 0.18 | 94.1 | 418 |
| 215 | A | 0.18 | 94.1 | 418 |
| 216 | A | 0.18 | 94.1 | 418 |
| 217 | A | 0.18 | 94.1 | 531 |
| 218 | B | 0.18 | 94.1 | 531 |
| 219 | B | 0.18 | 94.1 | 531 |
| 220 | B | 0.18 | 94.1 | 531 |
| 221 | B | 0.18 | 94.1 | 531 |
| 222 | B | 0.18 | 94.1 | 534 |
| 223 | B | 0.18 | 94.1 | 527 |
| 224 | B | 0.18 | 94.1 | 531 |
| 225 | B | 0.18 | 94.1 | 531 |

TABLE 1J

| | | | | Number |
|---|---|---|---|---|
| | | | | of |
| | | Material sheet | Winding | laminated |
| Experiment | Core | thickness | thickness | sheets |
| No. | type | (mm) | (mm) | (sheets) |
| 226 | B | 0.18 | 94.1 | 531 |
| 227 | B | 0.18 | 94.1 | 531 |
| 228 | B | 0.18 | 94.1 | 531 |
| 229 | B | 0.23 | 94.1 | 418 |
| 230 | B | 0.23 | 94.1 | 418 |
| 231 | B | 0.23 | 94.1 | 418 |
| 232 | B | 0.23 | 94.1 | 418 |
| 233 | B | 0.23 | 94.1 | 418 |
| 234 | B | 0.18 | 94.1 | 531 |
| 235 | B | 0.18 | 94.1 | 531 |
| 236 | B | 0.18 | 94.1 | 531 |
| 237 | B | 0.18 | 94.1 | 531 |
| 238 | B | 0.18 | 94.1 | 531 |

TABLE 2A

| | Joint portion 1 | | | Joint portion 2 | | | |
|---|---|---|---|---|---|---|---|
| Experiment | <Lᵢ> | <Lₒ> | | <L₂ᵢ> | <L₂ₒ> | | Core noise |
| No. | (mm) | (mm) | k | (mm) | (mm) | k2 | (dBA) |
| 1 | 1 | 1 | 8 | | | | 56 |
| 2 | 2 | 2 | 8 | | | | 56 |
| 3 | 5 | 5 | 8 | | | | 56 |
| 4 | 9 | 9 | 8 | | | | 56 |
| 5 | 15 | 15 | 8 | | | | 56 |
| 6 | 20 | 20 | 8 | | | | 56 |
| 7 | 25 | 25 | 8 | | | | 56 |
| 8 | 30 | 30 | 8 | | | | 56 |
| 9 | 40 | 40 | 8 | | | | 56 |
| 10 | 1 | 2 | 8 | | | | 56 |
| 11 | 2 | 4 | 8 | | | | 45 |
| 12 | 5 | 10 | 8 | | | | 45 |
| 13 | 9 | 18 | 8 | | | | 45 |
| 14 | 15 | 30 | 8 | | | | 45 |
| 15 | 20 | 40 | 8 | | | | 45 |
| 16 | 26 | 50 | 8 | | | | 56 |
| 17 | 30 | 55 | 8 | | | | 56 |
| 18 | 40 | 65 | 8 | | | | 56 |
| 19 | 1 | 3 | 8 | | | | 56 |
| 20 | 2 | 6 | 8 | | | | 37 |
| 21 | 5 | 15 | 8 | | | | 37 |
| 22 | 9 | 27 | 8 | | | | 37 |
| 23 | 15 | 45 | 8 | | | | 37 |
| 24 | 20 | 60 | 8 | | | | 37 |
| 25 | 26 | 65 | 8 | | | | 46 |

TABLE 2B

| | Joint portion 1 | | | Joint portion 2 | | | |
|---|---|---|---|---|---|---|---|
| Experiment | <Lᵢ> | <Lₒ> | | <L₂ᵢ> | <L₂ₒ> | | Core noise |
| No. | (mm) | (mm) | k | (mm) | (mm) | k2 | (dBA) |
| 26 | 30 | 70 | 8 | | | | 56 |
| 27 | 40 | 75 | 8 | | | | 56 |
| 28 | 1 | 10 | 8 | | | | 56 |
| 29 | 2 | 20 | 8 | | | | 42 |
| 30 | 5 | 50 | 8 | | | | 42 |
| 31 | 9 | 90 | 8 | | | | 42 |
| 32 | 15 | 150 | 8 | | | | 42 |
| 33 | 20 | 200 | 8 | | | | 42 |
| 34 | 26 | 250 | 8 | | | | 56 |
| 35 | 30 | 300 | 8 | | | | 56 |
| 36 | 40 | 300 | 8 | | | | 56 |
| 37 | 1 | 1 | 9 | | | | 56 |
| 38 | 2 | 2 | 9 | | | | 56 |
| 39 | 5 | 5 | 9 | | | | 56 |
| 40 | 9 | 9 | 9 | | | | 56 |
| 41 | 15 | 15 | 9 | | | | 56 |
| 42 | 20 | 20 | 9 | | | | 56 |
| 43 | 26 | 26 | 9 | | | | 56 |
| 44 | 30 | 30 | 9 | | | | 56 |
| 45 | 40 | 40 | 9 | | | | 56 |
| 46 | 1 | 2 | 9 | | | | 56 |
| 47 | 2 | 4 | 9 | | | | 38 |
| 48 | 2 | 4 | 9 | | | | 38 |
| 49 | 2 | 4 | 9 | | | | 38 |
| 50 | 2 | 4 | 9 | | | | 38 |

TABLE 2C

| | Joint portion 1 | | | Joint portion 2 | | | |
|---|---|---|---|---|---|---|---|
| Experiment | <Lᵢ> | <Lₒ> | | <L₂ᵢ> | <L₂ₒ> | | Core noise |
| No. | (mm) | (mm) | k | (mm) | (mm) | k2 | (dBA) |
| 51 | 2 | 4 | 9 | | | | 38 |
| 52 | 2 | 4 | 9 | | | | 38 |
| 53 | 2 | 4 | 9 | | | | 38 |
| 54 | 5 | 10 | 9 | | | | 38 |
| 55 | 9 | 18 | 9 | | | | 38 |
| 56 | 15 | 30 | 9 | | | | 38 |
| 57 | 20 | 40 | 9 | | | | 38 |
| 58 | 26 | 50 | 9 | | | | 56 |
| 59 | 30 | 55 | 9 | | | | 56 |
| 60 | 40 | 65 | 9 | | | | 56 |
| 61 | 1 | 3 | 9 | | | | 56 |
| 62 | 2 | 6 | 9 | | | | 28 |
| 63 | 5 | 15 | 9 | | | | 28 |
| 64 | 9 | 27 | 9 | | | | 28 |
| 65 | 9 | 27 | 9 | | | | 28 |
| 66 | 9 | 27 | 9 | | | | 28 |
| 67 | 9 | 27 | 9 | | | | 28 |
| 68 | 9 | 27 | 9 | | | | 28 |
| 69 | 9 | 27 | 9 | | | | 28 |
| 70 | 9 | 27 | 9 | | | | 28 |
| 71 | 15 | 45 | 9 | | | | 28 |
| 72 | 20 | 60 | 9 | | | | 28 |
| 73 | 26 | 65 | 9 | | | | 54 |
| 74 | 30 | 70 | 9 | | | | 54 |
| 75 | 40 | 75 | 9 | | | | 54 |

TABLE 2D

| | Joint portion 1 | | | Joint portion 2 | | | |
|---|---|---|---|---|---|---|---|
| Experiment | <Lᵢ> | <Lₒ> | | <L₂ᵢ> | <L₂ₒ> | | Core noise |
| No. | (mm) | (mm) | k | (mm) | (mm) | k2 | (dBA) |
| 76 | 1 | 10 | 9 | | | | 54 |
| 77 | 2 | 20 | 9 | | | | 38 |
| 78 | 5 | 50 | 9 | | | | 38 |
| 79 | 9 | 90 | 9 | | | | 38 |
| 80 | 15 | 150 | 9 | | | | 38 |
| 81 | 15 | 150 | 9 | | | | 38 |
| 82 | 15 | 150 | 9 | | | | 38 |
| 83 | 20 | 200 | 9 | | | | 38 |
| 84 | 26 | 250 | 9 | | | | 56 |
| 85 | 30 | 300 | 9 | | | | 56 |
| 86 | 40 | 300 | 9 | | | | 56 |
| 87 | 1 | 1 | 13 | | | | 56 |
| 88 | 2 | 2 | 13 | | | | 56 |
| 89 | 5 | 5 | 13 | | | | 56 |
| 90 | 9 | 9 | 13 | | | | 56 |
| 91 | 15 | 15 | 13 | | | | 56 |
| 92 | 20 | 20 | 13 | | | | 56 |
| 93 | 26 | 26 | 13 | | | | 56 |
| 94 | 30 | 30 | 13 | | | | 56 |
| 95 | 40 | 40 | 13 | | | | 56 |
| 96 | 1 | 2 | 13 | | | | 56 |
| 97 | 2 | 4 | 13 | | | | 40 |
| 98 | 5 | 10 | 13 | | | | 40 |
| 99 | 9 | 18 | 13 | | | | 40 |
| 100 | 15 | 30 | 13 | | | | 40 |

TABLE 2E

| | Joint portion 1 | | | Joint portion 2 | | | |
|---|---|---|---|---|---|---|---|
| Experiment | <Lᵢ> | <Lₒ> | | <L₂ᵢ> | <L₂ₒ> | | Core noise |
| No. | (mm) | (mm) | k | (mm) | (mm) | k2 | (dBA) |
| 101 | 20 | 40 | 13 | | | | 40 |
| 102 | 26 | 50 | 13 | | | | 56 |
| 103 | 30 | 55 | 13 | | | | 56 |
| 104 | 40 | 65 | 13 | | | | 56 |
| 105 | 1 | 3 | 13 | | | | 56 |
| 106 | 2 | 6 | 13 | | | | 35 |
| 107 | 5 | 15 | 13 | | | | 35 |
| 108 | 9 | 27 | 13 | | | | 35 |
| 109 | 15 | 45 | 13 | | | | 35 |
| 110 | 20 | 60 | 13 | | | | 35 |
| 111 | 26 | 65 | 13 | | | | 56 |
| 112 | 30 | 70 | 13 | | | | 56 |
| 113 | 40 | 75 | 13 | | | | 56 |
| 114 | 1 | 10 | 13 | | | | 56 |
| 115 | 2 | 20 | 13 | | | | 44 |
| 116 | 5 | 50 | 13 | | | | 44 |
| 117 | 9 | 90 | 13 | | | | 44 |
| 118 | 15 | 150 | 13 | | | | 44 |
| 119 | 20 | 200 | 13 | | | | 44 |
| 120 | 26 | 250 | 13 | | | | 56 |
| 121 | 30 | 300 | 13 | | | | 56 |
| 122 | 40 | 300 | 13 | | | | 56 |
| 123 | 1 | 1 | 20 | | | | 56 |
| 124 | 2 | 2 | 20 | | | | 56 |
| 125 | 5 | 5 | 20 | | | | 56 |

TABLE 2F

| | Joint portion 1 | | | Joint portion 2 | | | |
|---|---|---|---|---|---|---|---|
| Experiment | <Lᵢ> | <Lₒ> | | <L₂ᵢ> | <L₂ₒ> | | Core noise |
| No. | (mm) | (mm) | k | (mm) | (mm) | k2 | (dBA) |
| 126 | 9 | 9 | 20 | | | | 56 |
| 127 | 15 | 15 | 20 | | | | 56 |
| 128 | 20 | 20 | 20 | | | | 56 |
| 129 | 26 | 26 | 20 | | | | 56 |
| 130 | 30 | 30 | 20 | | | | 56 |
| 131 | 40 | 40 | 20 | | | | 56 |
| 132 | 1 | 2 | 20 | | | | 56 |
| 133 | 2 | 4 | 20 | | | | 38 |
| 134 | 5 | 10 | 20 | | | | 38 |
| 135 | 9 | 18 | 20 | | | | 38 |
| 136 | 15 | 30 | 20 | | | | 38 |
| 137 | 20 | 40 | 20 | | | | 38 |
| 138 | 26 | 50 | 20 | | | | 56 |
| 139 | 30 | 55 | 20 | | | | 56 |
| 140 | 40 | 65 | 20 | | | | 56 |
| 141 | 1 | 3 | 20 | | | | 56 |
| 142 | 2 | 6 | 20 | | | | 38 |
| 143 | 5 | 15 | 20 | | | | 38 |
| 144 | 9 | 27 | 20 | | | | 38 |
| 145 | 15 | 45 | 20 | | | | 38 |
| 146 | 20 | 60 | 20 | | | | 38 |
| 147 | 26 | 65 | 20 | | | | 56 |
| 148 | 30 | 70 | 20 | | | | 56 |
| 149 | 40 | 75 | 20 | | | | 56 |
| 150 | 1 | 10 | 20 | | | | 56 |

TABLE 2G

| | Joint portion 1 | | | Joint portion 2 | | | |
|---|---|---|---|---|---|---|---|
| Experiment | <Lᵢ> | <Lₒ> | | <L₂ᵢ> | <L₂ₒ> | | Core noise |
| No. | (mm) | (mm) | k | (mm) | (mm) | k2 | (dBA) |
| 151 | 2 | 20 | 20 | | | | 38 |
| 152 | 5 | 50 | 20 | | | | 38 |
| 153 | 9 | 90 | 20 | | | | 38 |
| 154 | 15 | 150 | 20 | | | | 38 |
| 155 | 20 | 200 | 20 | | | | 38 |
| 156 | 26 | 250 | 20 | | | | 56 |
| 157 | 30 | 300 | 20 | | | | 56 |
| 158 | 40 | 300 | 20 | | | | 56 |
| 159 | 1 | 1 | 23 | | | | 56 |
| 160 | 2 | 2 | 23 | | | | 56 |
| 161 | 5 | 5 | 23 | | | | 56 |
| 162 | 9 | 9 | 23 | | | | 56 |
| 163 | 15 | 15 | 23 | | | | 56 |
| 164 | 20 | 20 | 23 | | | | 56 |
| 165 | 26 | 26 | 23 | | | | 56 |
| 166 | 30 | 30 | 23 | | | | 56 |
| 167 | 40 | 40 | 23 | | | | 56 |
| 168 | 1 | 2 | 23 | | | | 56 |
| 169 | 2 | 4 | 23 | | | | 45 |
| 170 | 5 | 10 | 23 | | | | 45 |
| 171 | 9 | 18 | 23 | | | | 45 |
| 172 | 15 | 30 | 23 | | | | 45 |
| 173 | 20 | 40 | 23 | | | | 45 |
| 174 | 26 | 50 | 23 | | | | 56 |
| 175 | 30 | 55 | 23 | | | | 56 |

TABLE 2H

| | Joint portion 1 | | | Joint portion 2 | | | |
|---|---|---|---|---|---|---|---|
| Experiment | <Lᵢ> | <Lₒ> | | <L₂ᵢ> | <L₂ₒ> | | Core noise |
| No. | (mm) | (mm) | k | (mm) | (mm) | k2 | (dBA) |
| 176 | 40 | 65 | 23 | | | | 56 |
| 177 | 1 | 3 | 23 | | | | 56 |
| 178 | 2 | 6 | 23 | | | | 37 |
| 179 | 5 | 15 | 23 | | | | 37 |
| 180 | 9 | 27 | 23 | | | | 37 |
| 181 | 15 | 45 | 23 | | | | 37 |
| 182 | 20 | 60 | 23 | | | | 37 |
| 183 | 26 | 65 | 23 | | | | 56 |
| 184 | 30 | 70 | 23 | | | | 56 |
| 185 | 40 | 75 | 23 | | | | 56 |
| 186 | 1 | 10 | 23 | | | | 56 |
| 187 | 2 | 20 | 23 | | | | 42 |
| 188 | 5 | 50 | 23 | | | | 42 |
| 189 | 9 | 90 | 23 | | | | 42 |
| 190 | 15 | 150 | 23 | | | | 42 |
| 191 | 20 | 200 | 23 | | | | 42 |
| 192 | 26 | 250 | 23 | | | | 56 |
| 193 | 30 | 300 | 23 | | | | 56 |
| 194 | 40 | 300 | 23 | | | | 56 |
| 195 | 1 | 3 | 13 | 1 | 3 | 13 | 59 |
| 196 | 2 | 6 | 13 | 2 | 6 | 13 | 29 |
| 197 | 5 | 15 | 13 | 5 | 15 | 13 | 29 |
| 198 | 5 | 15 | 13 | 5 | 15 | 13 | 29 |
| 199 | 5 | 15 | 13 | 5 | 15 | 13 | 29 |
| 200 | 5 | 15 | 13 | 5 | 15 | 13 | 29 |

TABLE 2I

| | Joint portion 1 | | | Joint portion 2 | | | |
|---|---|---|---|---|---|---|---|
| Experiment | <Lᵢ> | <Lₒ> | | <L₂ᵢ> | <L₂ₒ> | | Core noise |
| No. | (mm) | (mm) | k | (mm) | (mm) | k2 | (dBA) |
| 201 | 9 | 27 | 13 | 9 | 27 | 13 | 29 |
| 202 | 15 | 45 | 13 | 15 | 45 | 13 | 29 |
| 203 | 20 | 60 | 13 | 20 | 60 | 13 | 29 |
| 204 | 26 | 65 | 13 | 26 | 65 | 13 | 59 |
| 205 | 30 | 70 | 13 | 30 | 70 | 13 | 59 |
| 206 | 40 | 75 | 13 | 40 | 75 | 13 | 59 |
| 207 | 30 | 55 | 13 | | | | 56 |
| 208 | 40 | 65 | 13 | | | | 56 |
| 209 | 1 | 3 | 13 | | | | 56 |
| 210 | 2 | 6 | 13 | | | | 35 |
| 211 | 5 | 15 | 13 | | | | 35 |
| 212 | 9 | 27 | 13 | | | | 35 |
| 213 | 15 | 45 | 13 | | | | 35 |
| 214 | 20 | 60 | 13 | | | | 35 |
| 215 | 26 | 65 | 13 | | | | 56 |
| 216 | 30 | 70 | 13 | | | | 56 |
| 217 | 40 | 75 | 13 | | | | 56 |
| 218 | 1 | 3 | 13 | 1 | 3 | 13 | 59 |
| 219 | 2 | 6 | 13 | 2 | 6 | 13 | 29 |
| 220 | 5 | 15 | 13 | 5 | 15 | 13 | 29 |
| 221 | 9 | 27 | 13 | 9 | 27 | 13 | 29 |
| 222 | 9 | 27 | 13 | 9 | 27 | 13 | 29 |
| 223 | 9 | 27 | 13 | 9 | 27 | 13 | 29 |
| 224 | 15 | 45 | 13 | 15 | 45 | 13 | 29 |
| 225 | 20 | 60 | 13 | 20 | 60 | 13 | 29 |

TABLE 2J

| | Joint portion 1 | | | Joint portion 2 | | | |
|---|---|---|---|---|---|---|---|
| Experiment | <Lᵢ> | <Lₒ> | | <L₂ᵢ> | <L₂ₒ> | | Core noise |
| No. | (mm) | (mm) | k | (mm) | (mm) | k2 | (dBA) |
| 226 | 26 | 65 | 13 | 26 | 65 | 13 | 59 |
| 227 | 30 | 70 | 13 | 30 | 70 | 13 | 59 |
| 228 | 40 | 75 | 13 | 40 | 75 | 13 | 59 |
| 229 | 2 | 3 | 13 | 1 | 3 | 13 | 45 |
| 230 | 20 | 35 | 13 | 10 | 10 | 13 | 43 |
| 231 | 20 | 45 | 13 | 30 | 70 | 13 | 45 |
| 232 | 24 | 70 | 13 | 30 | 70 | 13 | 43 |
| 233 | 24 | 75 | 13 | 40 | 75 | 13 | 43 |
| 234 | 15 | 20 | 13 | 5 | 15 | 13 | 43 |
| 235 | 20 | 35 | 13 | 10 | 10 | 13 | 45 |
| 236 | 20 | 45 | 13 | 30 | 70 | 13 | 40 |
| 237 | 26 | 65 | 13 | 24 | 65 | 13 | 43 |
| 238 | 24 | 70 | 13 | 30 | 70 | 13 | 43 |

As shown in Tables 2A to 2J, in the case of the core A having one joint portion, when <Li> and <Lo> satisfied the above expressions (1) and (2), the noise was improved. In addition, when <Li> and <Lo> satisfied the above expressions (1) and (2), and the number k was 9 to 20, the noise was further improved.

Further, as shown in Tables 2A to 2J, in the case of the core having two joint portions, when <Li> and <Lo> satisfied the above expressions (1) and (2), and <L₂ᵢ> and <L_{2O}> satisfied the above expressions (4) and (5), the noise was improved. When <Lᵢ>, <Lo>, <L₂ᵢ>, and <L_{2O}> satisfied the above expressions (1), (2), (3), and (4), and the numbers k and k2 were 9 to 20, the noise was further improved.

### Experimental Example 2

### [Manufacture of Wound Core]

Grain-oriented electrical steel sheets having a sheet thickness in Table 3 (sheet width: 152.4 mm, sheet thickness: 0.23 mm or 0.18 mm, Si content: 3.45 mass %) were sheared and bent so that the average distance of first-group joint portions Vᵢ<Lᵢ>, the average distance of second-group joint portions V_{O}<L_{O}>, the average distance of third-group joint portions V₂ᵢ <L₂ᵢ>, the average distance of fourth-group joint portions V₂ₒ <L_{2O}>, the number k, and the number k2 in Table 4 were obtained to prepare bent bodies, and the bent bodies were laminated in the sheet thickness direction to obtain a wound core in FIG. 13. The bending angle of the bent region, the radius of curvature of the bent region, (the length between the imaginary line A and the imaginary line C along the longitudinal direction)/(the length between the first imaginary line H1 and the second imaginary line H2 along the longitudinal direction), and each dimension of each experimental example were set as shown in Table 3. One joint portion was provided in Experiment Nos. 1B, 3B, 4B, and 7B to 13B, and two joint portions were provided in Experiment Nos. 2B, 5B, and 6B. Two joint portions of each of the bent bodies of Experiment Nos. 2B, 5B, and 6B are in two flat regions facing each other. In Table 4K, the column of joint portion 1 means a joint portion of a flat part having a reference flat region, and a joint portion 2 means a joint portion of a flat part having a second reference flat region.

### [Evaluation of Noise]

In noise measurement, the wound cores of Experiment Nos. 1B to 13B in Table 4 were prepared and excited, and the noise measurement was performed. This noise measurement was performed in an anechoic chamber with a background noise of 16 dBA with a noise meter installed at a position of 0.3 m from the core surface using an A-weighted network. In the excitation, the frequency was set to 50 Hz, and the magnetic flux density was set to 1.7 T. A core noise of 45 dBA or less was regarded as acceptable.

As shown in Table 4, the noise was improved in Experiment Nos. 1B to 9B and 11B to 13B. Also, when the number k was 9 to 20, the noise was further improved. In Experiment No. 10B, the noise was not improved because the radius of curvature exceeded 5.0 mm.

TABLE 3

| | | | | | | | Ratio of length | | | |
|---|---|---|---|---|---|---|---|---|---|---|
| | | | | | | | between imaginary | | | |
| | | | | | | | line A and imaginary | | | |
| | | | | | | | line C/(length | | | |
| | | Radius | | | | | between first | Material | | Number of |
| | Bending | of | | | | | imaginary line H1 | sheet | Winding | laminated |
| Core | angle | curvature | L1 | L2 | L3 | L4 | and second | thickness | thickness | sheets |
| specification | (°) | (mm) | (mm) | (mm) | (mm) | (mm) | imaginary line H2) | (mm) | (mm) | (sheets) |
| a | 45 | 0.2 | 344 | 122 | 94.1 | 4 | 0.50 | 0.23 | 94.1 | 418 |
| b | 45 | 1.0 | 344 | 122 | 94.1 | 4 | 0.50 | 0.23 | 94.1 | 418 |
| b′ | 45 | 1.0 | 344 | 122 | 94.1 | 4 | 0.90 | 0.23 | 94.1 | 418 |
| c | 45 | 2.9 | 344 | 122 | 94.1 | 4 | 0.50 | 0.23 | 94.1 | 418 |
| c′ | 45 | 2.9 | 344 | 122 | 94.1 | 4 | 0.90 | 0.23 | 94.1 | 418 |
| d | 45 | 4.9 | 344 | 122 | 94.1 | 4 | 0.50 | 0.23 | 94.1 | 418 |
| e | 45 | 10.0 | 344 | 122 | 94.1 | 4 | 0.50 | 0.23 | 94.1 | 418 |
| f | 30 | 1.0 | 344 | 122 | 94.1 | 4 | 0.50 | 0.23 | 94.1 | 418 |
| g | 30 | 2.9 | 344 | 122 | 94.1 | 4 | 0.50 | 0.23 | 94.1 | 418 |
| h | 60 | 1.0 | 344 | 122 | 94.1 | 4 | 0.50 | 0.23 | 94.1 | 418 |

TABLE 4

| | Core | Joint portion 1 | | | Joint portion 2 | | | Core |
|---|---|---|---|---|---|---|---|---|
| Experiment | specifi- | <Li> | <Lo> | | <L₂ᵢ> | <L₂ₒ> | | noise |
| No. | cation | (mm) | (mm) | k | (mm) | (mm) | k2 | (dBA) |
| 1B | a | 9 | 27 | 9 | | | | 29 |
| 2B | a | 9 | 27 | 9 | 9 | 27 | 9 | 29 |
| 3B | b | 5 | 10 | 9 | | | | 40 |
| 4B | b′ | 5 | 10 | 9 | | | | 39 |
| 5B | b | 5 | 15 | 13 | 5 | 15 | 13 | 40 |
| 6B | b′ | 5 | 15 | 13 | 5 | 15 | 13 | 39 |
| 7B | c | 9 | 27 | 9 | | | | 32 |
| 8B | c′ | 9 | 27 | 9 | | | | 30 |
| 9B | d | 5 | 10 | 9 | | | | 40 |
| 10B | e | 15 | 30 | 20 | | | | 47 |
| 11B | f | 5 | 15 | 13 | | | | 30 |
| 12B | g | 15 | 30 | 20 | | | | 39 |
| 13B | h | 5 | 15 | 13 | | | | 29 |

### Field of Industrial Application

According to the present disclosure, noise of a wound core can be suppressed. Therefore, industrial applicability is large.

### BRIEF DESCRIPTION OF THE REFERENCE SYMBOLS

1 Bent body
2 Laminated body
3 Corner portion
4, 4a, 4b Flat part
5, 5a, 5b Bent region
6 Joint portion
8 Flat region
10 Wound core
20 Bending device
40 Manufacturing apparatus
21 Grain-oriented electrical steel sheet
22 Die
23 Guide
24 Punch
25 Conveyance direction
26 Pressurization direction

1. A wound core formed by laminating, in a sheet thickness direction, a plurality of bent bodies formed from a grain-oriented electrical steel sheet, wherein
the wound core has a plurality of flat parts and a plurality of corner portions,
the bent body has a plurality of flat regions and a plurality of bent regions adjacent to the flat regions,
a radius of curvature of each of the bent regions is 5.0 mm or less,
the bent body has one or more joint portions in which end surfaces of the grain-oriented electrical steel sheets in a longitudinal direction face each other, and
when the bent body disposed on the innermost side is defined as a first bent body and a flat region where the joint portion of the first bent body is present is defined as a reference flat region, the joint portion of each of the plurality of bent bodies is located in the flat part having the reference flat region, and
in a side view of the wound core,
when one bent region adjacent to the reference flat region is defined as a first bent region,
the other bent region adjacent to the reference flat region is defined as a second bent region,
an imaginary line passing through an end point of the first bent region on the reference flat region side and parallel to the sheet thickness direction of the reference flat region is defined as a first imaginary line,
an imaginary line passing through an end point of the second bent region on the reference flat region side and parallel to the sheet thickness direction of the reference flat region is defined as a second imaginary line,
among the joint portions of the flat part having the reference flat region, the joint portion located between the first imaginary line and the second imaginary line and having the shortest length from the first imaginary line to the end surface of the joint portion on the first imaginary line side along the longitudinal direction of the reference flat region is defined as a first shortest joint portion,
among the joint portions in the bent bodies adjacent in the sheet thickness direction to the bent body having the first shortest joint portion, the joint portion located between the first imaginary line and the second imaginary line and having a shorter length from the first imaginary line to the end surface of the joint portion on the first imaginary line side along the longitudinal direction of the reference flat region is defined as a first end joint portion,
among the joint portions of the flat part having the reference flat region, the joint portion located between the first imaginary line and the second imaginary line and having the shortest length from the second imaginary line to the end surface of the joint portion on the second imaginary line side along the longitudinal direction of the reference flat region is defined as a second shortest joint portion,
among the joint portions in the bent body adjacent in the sheet thickness direction to the bent body having the second shortest joint portion, the joint portion located between the first imaginary line and the second imaginary line and having a shorter length from the second imaginary line to the end surface of the joint portion on the second imaginary line side along the longitudinal direction of the reference flat region is defined as a second end joint portion,
an imaginary line passing through the end surface of the first shortest joint portion on the first imaginary line side and parallel to the sheet thickness direction of the reference flat region is defined as an imaginary line A,
an imaginary line passing through the end surface of the first end joint portion on the first imaginary line side and parallel to the sheet thickness direction of the reference flat region is defined as an imaginary line B,
an imaginary line passing through the end surface of the second shortest joint portion on the second imaginary line side and parallel to the sheet thickness direction of the reference flat region is defined as an imaginary line C,
an imaginary line passing through the end surface of the second end joint portion on the second imaginary line side and parallel to the sheet thickness direction of the reference flat region is defined as an imaginary line D,
among the joint portions of the flat part having the reference flat region, the joint portion located between the imaginary line A and the imaginary line B is defined as a first-group joint portion,
among the joint portions of the flat part having the reference flat region, the joint portion located between the imaginary line C and the imaginary line D is defined as a second-group joint portion,
an average of lengths from the first imaginary line to the end surface of each of the first-group joint portions on the first imaginary line side along the longitudinal direction of the reference flat region is defined as <Lᵢ>, and
an average of lengths from the second imaginary line to the end surface of each of the second-group joint portions on the second imaginary line side along the longitudinal direction of the reference flat region is defined as <L_{O}>,
the wound core satisfies the following expressions (1) and (2),
$$2 mm \leq 〈 {L}_{i} 〉 < 25 mm \qquad ( 1 )$$
$$1.22 * 〈 Li 〉 \leq 〈 {L}_{O} 〉 . \qquad ( 2 )$$

2. The wound core according to claim 1, wherein
the number of first-group joint portions is equal to the number of second-group joint portions, and
among a quotient and a remainder obtained by dividing the number of joint portions in the flat part located between the first imaginary line and the second imaginary line and having the reference flat region by the number of first-group joint portions, k, which is the quotient, satisfies the following expression (3),
$$9 \leq k \leq 20 . \qquad ( 3 )$$

3. The wound core according to claim 1, wherein
the bent bodies have the joint portion in each of two flat regions facing each other,
the first bent body has the reference flat region and a second reference flat region facing the reference flat region, and
the joint portion of each of the plurality of bent bodies is located in the flat part having the reference flat region and the flat part having the second reference flat region, and
in a side view of the wound core,
when one bent region adjacent to the second reference flat region is defined as a third bent region,
the other bent region adjacent to the second reference flat region is defined as a fourth bent region,
an imaginary line passing through an end point of the third bent region on the second reference flat region side and parallel to the sheet thickness direction of the second reference flat region is defined as a third imaginary line,
an imaginary line passing through an end point of the fourth bent region on the second reference flat region side and parallel to the sheet thickness direction of the second reference flat region is defined as a fourth imaginary line,
among the joint portions of the flat part having the second reference flat region, the joint portion located between the third imaginary line and the fourth imaginary line and having the shortest length from the third imaginary line to the end surface of the joint portion on the third imaginary line side along the longitudinal direction of the second reference flat region is defined as a third shortest joint portion,
among the joint portions in the bent bodies adjacent in the sheet thickness direction to the bent body having the third shortest joint portion, the joint portion located between the third imaginary line and the fourth imaginary line and having a shorter length from the third imaginary line to the end surface of the joint portion on the third imaginary line side along the longitudinal direction of the second reference flat region is defined as a third end joint portion,
among the joint portions of the flat part having the second reference flat region, the joint portion located between the third imaginary line and the fourth imaginary line and having the shortest length from the fourth imaginary line to the end surface of the joint portion on the fourth imaginary line side along the longitudinal direction of the second reference flat region is defined as a fourth shortest joint portion,
among the joint portions in the bent body adjacent in the sheet thickness direction to the bent body having the fourth shortest joint portion, the joint portion located between the third imaginary line and the fourth imaginary line and having a shorter length from the fourth imaginary line to the end surface of the joint portion on the fourth imaginary line side along the longitudinal direction of the second reference flat region is defined as a fourth end joint portion,
an imaginary line passing through the end surface of the third shortest joint portion on the third imaginary line side and parallel to the sheet thickness direction of the second reference flat region is defined as an imaginary line E,
an imaginary line passing through the end surface of the third end joint portion on the third imaginary line side and parallel to the sheet thickness direction of the second reference flat region is defined as an imaginary line F,
an imaginary line passing through the end surface of the fourth shortest joint portion on the fourth imaginary line side and parallel to the sheet thickness direction of the second reference flat region is defined as an imaginary line G,
an imaginary line passing through the end surface of the fourth end joint portion on the fourth imaginary line side and parallel to the sheet thickness direction of the second reference flat region is defined as an imaginary line H,
among the joint portions of the flat part having the second reference flat region, the joint portion located between the imaginary line E and the imaginary line F is defined as a third-group joint portion,
among the joint portions of the flat part having the second reference flat region, the joint portion located between the imaginary line G and the imaginary line H is defined as a fourth-group joint portion,
an average of lengths from the third imaginary line to the end surface of each of the third-group joint portions on the third imaginary line side along the longitudinal direction of the second reference flat region is defined as <L₂ᵢ>, and
an average of lengths from the fourth imaginary line to the end surface of each of the fourth-group joint portions on the fourth imaginary line side along the longitudinal direction of the second reference flat region is defined as <L_{2O}>,
the wound core satisfies the following expressions (4) and (5),
$$2 mm \leq 〈 {L}_{2 i} 〉 < 25 mm \qquad ( 4 )$$
$$1.22 * 〈 {L}_{2 i} 〉 \leq 〈 {L}_{2 O} 〉 . \qquad ( 5 )$$

4. The wound core according to claim 3, wherein
the number of third-group joint portions is equal to the number of fourth-group joint portions, and
among a second quotient and a second remainder obtained by dividing the number of joint portions in the flat part located between the third imaginary line and the fourth imaginary line and having the second reference flat region by the number of third-group joint portions, k2, which is the second quotient, satisfies the following expression (6),
$$9 \leq k 2 \leq 20 . \qquad ( 6 )$$

5. The wound core according to claim 1, wherein a bending angle of the bent region is 30° to 60°.
